(19) United States
(12) Patent Application Publication
(10) Pub. No.: US 2007/0146338 A1
(43) Pub. Date: Jun. 28, 2007

(54) Storage medium storing a training program, training apparatus and training control method

(75) Inventor: Toshikazu Kiuchi, Kyoto (JP)

Correspondence Address: NIXON & VANDERHYE, PC, 901 NORTH GLEBE ROAD, 11TH FLOOR, ARLINGTON, VA, 22203, US

(73) Assignee: Nintendo Co., Ltd., Kyoto (JP)

(21) Appl. No.: 11/384,405

(22) Filed: Mar. 21, 2006

(30) Foreign Application Priority Data
Dec. 28, 2005 (JP) 2005-376841

(51) Int. Cl. G09G 5/00

(52) U.S. Cl. 345/173

(57) ABSTRACT

A game apparatus includes a first LCD and a second LCD, and a touch panel is provided on the second LCD. A question screen is displayed on the first LCD, and an operation screen for answering the question is displayed on the second LCD. On the question screen, a plurality of points are connected by a connecting line to display figures, characters, symbols (figure, etc). The operation screen displays a figure, etc. displayed on the question screen with a part of the connecting line thereof erased. A player performs an operation on a touch panel so as to display a figure, etc. the same as the figure, etc. displayed on the question screen. The player touches the touch panel to determine a drawing start point, the determination area of a point to be connected with thereto is set to become large while the determination area of the point not to be connected thereto is set to become small.

### CROSS REFERENCE OF RELATED APPLICATION

The disclosure of Japanese Patent Application No. 2005-376841 is incorporated herein by reference.

### BACKGROUND OF THE INVENTION

1. Field of the Invention

The present invention relates to a storage medium storing a training program, a training apparatus, and a training control method. More specifically, the present invention relates to a storage medium storing a training program, a training apparatus, and a training control method which makes a player instruct a plurality of objects displayed on a screen with a pointing device to thereby cause a computer to execute a process relating to the instructed objects.

2. Description of the Related Art

An example of this kind of a conventional game apparatus is disclosed in a Japanese Patent Laying-open No. 2005-237680 [A63F 13/06, A63F 13/00, G06F 3/03, G06F 3/033] laid-open on Sep. 8, 2005. The game apparatus is provided with a touch panel in association with an LCD, and on the touch panel, operation buttons each corresponding to each of the player characters is set. The setting of the operation buttons is changed depending on an operation state (frequency of usage, operation coordinates position) by the player during the game play. For example, the size of the operation button is changed depending on the frequency of usage. Also, an operation effective area and a display position of the operation button are changed depending on the operation coordinates position. Thus, the operation button is set so as to be suitable for the player, thereby, improving operability.

The game apparatus of the related art is effective in a case that a preset role is set to each object such as an operation button, or in a case that the number of objects to be simultaneously displayed on the screen in association with the touch panel is limited. However, if the number of objects to be displayed is successively changed, that is, if changing the size of the object depending on the frequency of usage (frequency of operation) and changing the operation effective area and the display position depending on the operation coordinates position are more effective, it is impossible to fetch a operation coordinates position for each object. Additionally, if a multiplicity of objects are displayed on the touch panel, changing the size of the object, the operation effective area, and the display position are substantially impossible, thus eliminating obtainment of the advantage caused by the changes.

### SUMMARY OF THE INVENTION

Therefore, it is a primary object of the present invention to provide a novel storage medium storing a training program, training apparatus, and training control method.

Another object of the present invention is to provide a storage medium storing a training program, a training apparatus and a training control method allowing a player to smoothly make an operation irrespective of the number of objects.

A storage medium storing a training program according to the present invention stores a training program which makes a player instruct a plurality of objects displayed on a screen with a pointing device to thereby cause a computer to execute a process relating to the instructed objects. The training program causes a computer to function as an input coordinates detecting means, a start object determining means, and a determination area setting means. The input coordinates detecting means detects input coordinates on the screen instructed by the pointing device. The start object determining means determines one start object out of all the objects on the basis of the input coordinates detected by the input coordinates detecting means. The determination area setting means sets a determination area corresponding to a next candidate object to be instructed next according to a predetermined condition stored in a storage means so as to become larger than a predetermined size when the start object is determined by the start object determining means.

More specifically, the training program makes a player to instruct a plurality of objects (122: reference number corresponding in a preferable embodiment described later) displayed on a screen (14) with a pointing device (22) to thereby cause a computer (42) to execute a process relating to the instructed object. The training program causes the computer to function as an input coordinates detecting means (42, S51), a start object determining means (42, S55), and a determination area setting means (42, S59). The input coordinates detecting means detects input coordinates on the screen to be instructed by a pointing device. The start object determining means determines one start object from all the objects on the basis of the input coordinates detected by the input coordinates detecting means. For example, an object existing in a position the closest to the input coordinates is determined as a start object. The determination area setting means sets a determination area (22a) corresponding to a next candidate object to be instructed next according to a predetermined condition (722b) stored in a storage means (48) so as to become larger than a predetermined size when the start object is determined.

According to the present invention, since a determination area of at least an object to be instructed next to the start object is set to become larger than the predetermine size, it becomes possible to easily instruct an object to be instructed next. Accordingly, it is possible to perform a smooth operation irrespective of the number of objects.

In one embodiment of the present invention, the determination area setting means sets a determination area corresponding to an object except for the next candidate object so as to become smaller than the predetermined size. More specifically, the determination area setting means sets a determination area corresponding to a next candidate object to be instructed next to the start object is set so as to become larger than the predetermined size, and a determination area corresponding to an object except for the next candidate object is set so as to become smaller than the predetermined size. Accordingly, if the objects are placed tightly with each other, or if a plurality of objects exist, it is possible to prevent the player from instructing an undesired object erroneously.

In another embodiment of the present invention, the determination area setting means sets the determination areas corresponding to all the objects to the predetermined size when the next candidate object is not present. More specifically, the determination area setting means, when the determined start object is erroneous, and a next candidate object to be instructed next to the start object is not present, the determination areas corresponding to all the objects are set to the predetermined size. Thus, when an object to be instructed next to the start object is not present, it is not necessary to set determination areas different in size, capable of reducing a processing load.

In another embodiment of the present invention, the predetermined size includes a display area of the object. More specifically, the predetermined size of the determination area includes a display area of the object. That is, the predetermined size is set to become larger than the display area of the object. Thus, if a determination area in the predetermined size is set to an object, even if the vicinity of the circumference of the object is instructed, it is possible to accurately determine instruction of the object.

In one aspect of the present invention, the training program further causes the computer to function as an object-related processing means, when the start object is determined by the start object determining means, and then, the input coordinates detected by the input coordinates detecting means is included in any of the determination areas, for executing a process relating to the object corresponding to the determination area. More specifically, the training program causes the computer to function as an object-related processing means (42, S79, S81, S89, S91, S93, S101, S103). The object-related processing means, when the start object is determined, and then, the detected input coordinates is included in any of the determination areas, executes a process relating to the object corresponding to the determination area. For example, the start object and an object corresponding to the determination area in which the input coordinates is included is determined are connected with each other. Also, when an object corresponding to the determination area in which the input coordinates is included is determined is not an object to be instructed next, it is determined to be erroneous. That is, a process relating to the object instructed next to the start object can be executed.

In another embodiment of the present invention, the predetermined condition is a pair of objects to be connected. More specifically, the predetermined condition is pairs of objects to be connected, and when one of the pair is determined as a start object, the other of the object becomes a next candidate object. That is, since the pairs of object are merely stored, it is easy to set the condition.

In another aspect of the present invention, the object-related processing means includes a true or false determining means, when the start object is determined, and then, the input coordinates is included in any of the determination areas, for determining whether an object corresponding to the determination area is the next candidate object or not, a connection information storage controlling means for storing in the storage means connection information indicating that the start object and the next candidate object are connected with each other when the object is determined to be the next candidate object by the true or false determining means, a connection determining means for determining whether or not all connection information as to the objects to be connected are stored by the connection information storage controlling means, and a purpose attainment determining means for determining that a purpose is attained when it is determined that all the connection information are stored in the storage means by the connection determining means. More specifically, the object-related processing means includes a true or false determining means (42, S83), a connection information storage controlling means (42, S87), a connection determining means (42, S89), and a purpose attainment determining means (42, S83, S85, S89, S91, S93). The true or false determining means, when the start object is determined, and then, the input coordinates is included in any of the determination areas, determines whether an object corresponding to the determination area is the next candidate object or not. That is, it is determined whether or not a user's (or player) instruction is correct. The connection information storage controlling means stores in the storage means (48) connection information (7222) indicating that the start object and the next candidate object are connected with each other when the object is determined to be the next candidate object by the true or false determining means. The connection determining means determines whether or not all connection information as to the objects to be connected by the connection information storage controlling means is stored. That is, it is determined that all the objects to be connected are connected with each other. The purpose attainment determining means determines that a purpose is attained when it is determined that all the connection information are stored in the storage means by the connection determining means (“NO” in S89). Thus, when all the objects to be connected are connected, the purpose is attained is determined, providing the user who is training with feel of accomplishment.

In one embodiment of the present invention, the purpose attainment determining means determines that the purpose is not attained when the true or false determining means determines that the object is not the next candidate object. More specifically, the true or false determining means, when the next candidate object to be instructed next to the start object is not instructed, determines that the instruction by the user is erroneous. At this time, the purpose attainment determining means determines that the purpose is not attained. Thus, if the instruction by the user is erroneous, the purpose is not attained is determined, and therefore, it is possible to execute a process such as informing the user of the erroneous instruction.

In another embodiment of the present invention, the start object determining means determines the start object when the input coordinates detecting means detects a shift from a state in which the input coordinates is not detected to a state in which the input coordinates is detected, or when the true or false determining means determines that the object is the next candidate object. More specifically, the start object determining means determines the start object when the input coordinates detecting means detects a shift from a state in which the input coordinates is not detected to a state in which the input coordinates is detected (“YES” in S5), or when the true or false determining means determines that the object is the next candidate object (“YES” in S83). That is, when an input is started, or when certain objects are connected with each other once, the start object is determined, and therefore, for one instruction operation, a pair of objects can be connected, or two pairs of objects or more can be connected with each other.

A training apparatus according to the present invention makes a player instruct a plurality of objects displayed on a screen with a pointing device to thereby cause a computer to execute a process relating to the instructed objects. The training apparatus includes an input coordinates detecting means, a start object determining means, and a determination area setting means. The input coordinates detecting means detects input coordinates on the screen to be instructed by the pointing device. The start object determining means determines one start object out of all the objects on the basis of the input coordinates detected by the input coordinates detecting means. The determination area setting means sets a determination area corresponding to a next candidate object to be instructed next according to a predetermined condition stored in the storage means so as to become larger than a predetermined size when the start object is determined by the start object determining means.

In the invention of the training apparatus also, it is possible to perform a smooth operation irrespective of the number of objects similarly to the above-described storing medium.

A training control method according to the present invention makes a player instruct a plurality of objects displayed on a screen with a pointing device to thereby cause a computer to execute a process relating to the instructed objects. The training control method (a) detecting input coordinates on the screen to be instructed by the pointing device, (b) determining one start object out of all the objects on the basis of the input coordinates detected by the step (a), and (c) setting a determination area corresponding to a next candidate object to be instructed next according to a predetermined condition stored in the storage means so as to become larger than a predetermined size when the start object is determined by the step (b).

In the invention of the training control method, it is possible to perform a smooth operation irrespective of the number of objects similarly to the above-described storing medium.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing a game apparatus of the present invention;

FIG. 2 is a block diagram showing an electric configuration of the game apparatus shown in FIG. 1 embodiment;

FIG. 3 is an illustrative view showing one example of a question screen and an operation screen to be displayed on LCDs in FIG. 1 embodiment;

FIG. 4 is an illustrative view showing another example of the question screen and the operation screen to be displayed on the LCDs in FIG. 1 embodiment;

FIG. 5 is an illustrative view for explaining a display method of the operation screen shown in FIG. 4;

FIG. 6 is an illustrative view showing an operation example and a display example of the operation screen shown in FIG. 4, and a determination area to be set on a touch panel;

FIG. 7 is an illustrative view showing another operation example and display example of the operation screen shown in FIG. 4, and a determination area to be set on the touch panel;

FIG. 8 is an illustrative view showing the other operation example and display example of the operation screen shown in FIG. 4, and a determination area to be set on the touch panel;

FIG. 9 is an illustrative view showing a further operation example and display example of the operation screen shown in FIG. 4, and a determination area to be set on the touch panel;

FIG. 10 is an illustrative view showing another operation example and display example of the operation screen shown in FIG. 4, and a determination area to be set on the touch panel;

FIG. 11 is an illustrative view showing the other operation example and display example of the operation screen shown in FIG. 4, and a determination area to be set on the touch panel;

FIG. 12 is an illustrative view showing a further operation example and display example of the operation screen shown in FIG. 4, and a determination area to be set on the touch panel;

FIG. 13 is an illustrative view showing another display example of the operation screen shown in FIG. 4;

FIG. 14 is an illustrative view showing a memory map of a RAM shown in FIG. 2;

FIG. 15 is an illustrative view showing an example of a content of a data storage area shown in FIG. 14;

FIG. 16 is a flowchart showing a game entire process of a CPU core shown in FIG. 2;

FIG. 17 is a flowchart showing a question screen generating and displaying process of the CPU core shown in FIG. 2;

FIG. 18 is a flowchart showing an operation screen generating and displaying process of the CPU core shown in FIG. 2;

FIG. 19 is a flowchart showing a touch-on process of the CPU core shown in FIG. 2;

FIG. 20 is a flowchart showing a part of the drawing process of the CPU core shown in FIG. 2;

FIG. 21 is a flowchart showing another part of the drawing process of the CPU core shown in FIG. 2 and continuing to FIG. 20;

FIG. 22 is a flowchart showing a determination area setting process of the CPU core shown in FIG. 2; and

FIG. 23 is an illustrative view for explaining a true or false determination method of a drag operation by the player in a case that points are arranged on a straight line.

### DETAILED DESCRIPTION OF THE PREFERRED EMBODIMENTS

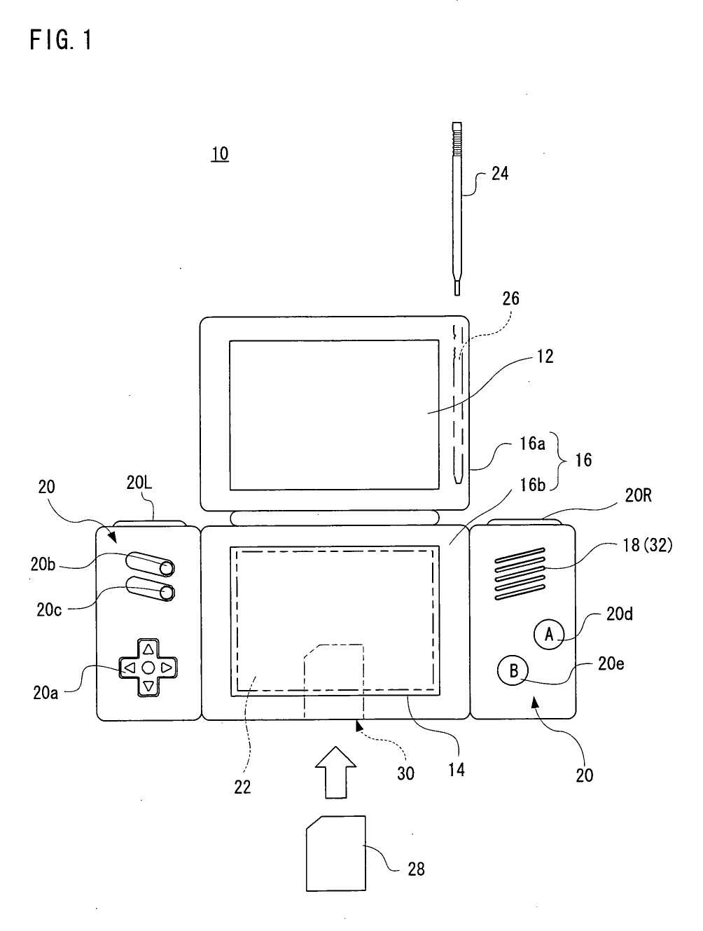

Referring to FIG. 1, a game apparatus 10 of one embodiment of the present invention has a program (training program) for training (rehabilitation exercise, learning, game) a brain and a tip of a finger, and functions as a training apparatus. The game apparatus 10 includes a first liquid crystal display (LCD) 12 and a second LCD 14. The LCD 12 and the LCD 14 are provided on a housing 16 so as to be arranged in a predetermined position. In this embodiment, the housing 16 comprises an upper housing 16a and a lower housing 16b, and the LCD 12 is provided on the upper housing 16a while the LCD 14 is provided on the lower housing 16b. Accordingly, the LCD 12 and the LCD 14 are closely arranged so as to be longitudinally (vertically) parallel with each other.

It is noted that although the LCD is utilized as a display in this embodiment, an EL (Electronic Luminescence) display and a plasma display may be used in place of the LCD.

As can be understood from FIG. 1, the upper housing 16a has a plane shape little larger than a plane shape of the LCD 12, and has an opening formed so as to expose a display surface of the LCD 12 from one main surface thereof. On the other hand, the lower housing 16b has a plane shape horizontally longer than the upper housing 16a, and has an opening formed so as to expose a display surface of the LCD 14 at an approximately center of the horizontal direction. Furthermore, the lower housing 16b is provided with a sound hole 18 and an operating switch 20 (20a, 20b, 20c, 20d, 20e, 20L and 20R).

In addition, the upper housing 16a and the lower housing 16b are rotatably connected at a lower side (lower edge) of the upper housing 16a and a part of an upper side (upper edge) of the lower housing 16b. Accordingly, in a case of not playing a game, for example, if the upper housing 16a is rotatably folded such that the display surface of the LCD 12 and the display surface of the LCD 14 are face to face with each other, it is possible to prevent the display surface of the LCD 12 and the display surface of the LCD 14 from being damaged such as a flaw, etc. It is noted that the upper housing 16a and the lower housing 16b are not necessarily rotatably connected with each other, and may alternatively be provided integrally (fixedly) to form the housing 16.

The operating switch 20 includes a direction instructing switch (cross switch) 20a, a start switch 20b, a select switch 20c, an action switch (A button) 20d, an action switch (B button) 20e, an action switch (L button) 20L, and an action switch (R button) 20R. The switches 20a, 20b and 20c are placed at the left of the LCD 14 on the one main surface of the lower housing 16b. Also, the switches 20d and 20e are placed at the right of the LCD 14 on the one main surface of the lower housing 16b. Furthermore, the switches 20L and 20R are placed in a part of an upper edge (top surface) of the lower housing 16b at a place except for a connected portion, and lie of each side of the connected portion with the upper housing 16a.

The direction instructing switch 20a functions as a digital joystick, and is utilized for instructing a moving direction of a player character (or player object) to be operated by a player, instructing a moving direction of a cursor, and so forth by operating any one of four depression portions. The start switch 20b is formed by a push button, and is utilized for starting (restarting), temporarily stopping (pausing) a game, and so forth. The select switch 20c is formed by the push button, and utilized for a game mode selection, etc.

The action switch 20d, that is, the A button is formed by the push button, and allows the player character to perform an arbitrary action, except for instructing the direction, such as hitting (punching), throwing, holding (obtaining), riding, jumping, etc. For example, in an action game, it is possible to apply an instruction of jumping, punching, moving arms, etc. In a role-playing game (RPG) and a simulation RPG, it is possible to apply an instruction of obtaining an item, selecting and determining arms or command, etc. The action switch 20e, that is, the B button is formed by the push button, and is utilized for changing a game mode selected by the select switch 20c, canceling an action determined by the A button 20d, and so forth.

The action switch (left depression button) 20L and the action switch (right depression button) 20R are formed by the push button, and the left depression button (L button) 20L and the right depression button (R button) 20R can perform the same operation as the A button 20d and the B button 20e, and also function as a subsidiary of the A button 20d and the B button 20e.

Also, on a top surface of the LCD 14, a touch panel 22 is provided. As the touch panel 22, any kinds of a resistance film system, an optical system (infrared rays system) and an electrostatic capacitive coupling system, for example, can be utilized. In response to an operation by depressing, stroking (touching), and so forth with a stick 24, a pen (stylus pen), or a finger (hereinafter, referred to as “stick 24, etc.”) on a top surface of the touch panel 22, the touch panel 22 detects coordinates (touch coordinates) of an operation position (touch position) by the stick 24, etc. to output coordinates data corresponding to the detected coordinates.

It is noted that in this embodiment, a resolution of the display surface of the LCD 14 is 256 dots×192 dots, and a detection accuracy of a detection surface of the touch panel 22 is also rendered 256 dots×192 dots in correspondence to the resolution of the display surface (this is true for the LCD 12). However, detection accuracy of the detection surface of the touch panel 22 may be lower than or higher than the resolution of the display surface of the LCD 14.

The LCD 12 and the LCD 14 can display different game images (game screens). For example, one LCD (LCD 12, for example) displays a game screen for playing the game, and the other LCD (LCD 14, for example) displays a game screen (operation screen) for inputting textual information to operate the game, and instructing a predetermined image (icon, etc.) Accordingly, the player can input the textual information (command) on the screen of the LCD 14, instruct a predetermined image (icon, etc.) by operating the touch panel 22 with a stick 24, etc.

Thus, the game apparatus 10 has the LCD 12 and the LCD 14 as a display portion of two screens, and by providing the touch panel 22 on an upper surface of any one of them (LCD 14 in this embodiment), the game apparatus 10 has the two screens (12, 14) and the operating portions (20, 22) of two systems.

Furthermore, in this embodiment, the stick 24 can be inserted into a housing portion (housing slot) 26 provided in proximity to a side surface (right side surface) of the upper housing 16a, for example, and taken out therefrom as necessary. It is noted that in a case no stick 14 is provided, the housing portion 26 also needs not to be provided.

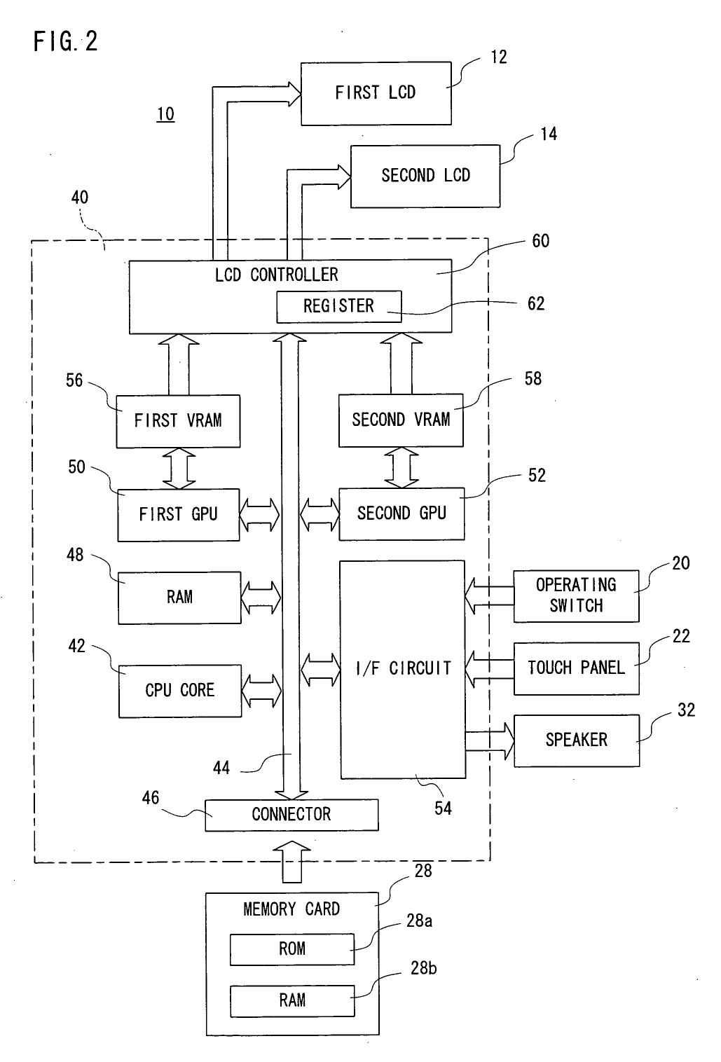

Also, the game apparatus 10 includes a memory card (or game cartridge) 28, and the memory card 28 is detachable, and inserted into a loading slot 30 provided on a rear surface or a lower edge (bottom surface) of the lower housing 16b. Although omitted in FIG. 1, a connector 46 (see FIG. 2) is provided at a depth portion of the loading slot 30 for connecting a connector (not shown) provided at an end portion of the memory card 28 in the loading direction, and when the memory card 28 is loaded into the loading slot 30, the connectors are connected with each other, and therefore, the memory card 28 is accessible by a CPU core 42 (see FIG. 2) of the game apparatus 10.

It is noted that although not illustrated in FIG. 1, a speaker 32 (see FIG. 2) is provided at a position corresponding to the sound hole 18 inside the lower housing 16b.

Furthermore although omitted in FIG. 1, for example, a battery accommodating box is provided on a rear surface of the lower housing 16b, and a power switch, a volume switch, an external expansion connector, an earphone jack, etc. are provided on a bottom surface of the lower housing 16b.

FIG. 2 is a block diagram showing an electric configuration of the game apparatus 10. Referring to FIG. 2, the game apparatus 10 includes an electronic circuit board 40, and on the electronic circuit board 40, a circuit component such as a CPU core 42, etc. is mounted. The CPU core 42 may be called a processor or a computer, is connected to the connector 46 via a bus 44, and is connected with a RAM 48, a first figure processing unit (GPU) 50, a second GPU 52, an input-output interface circuit (hereinafter, referred to as “I/F circuit”) 54, and an LCD controller 60.

The connector 46 is detachably connected with the memory card 28 as described above. The memory card 28 includes a ROM 28a and a RAM 28b, and although illustration is omitted, the ROM 28a and the RAM 28b are connected with each other via a bus and also connected with a connector (not shown) to be connected with the connector 46. Accordingly, the CPU core 42 gains access to the ROM 28a and the RAM 28b as described above.

The ROM 28a stores in advance a game program for a game (virtual game) to be executed by the game apparatus 10, image (character image, background image, item image, icon (button) image, message image, etc.) data, data of the sound (music) necessary for the game (sound data), etc. The RAM (backup RAM) 28b stores (saves) proceeding data and result data of the game.

The RAM 48 is utilized as a buffer memory or a working memory. That is, the CPU core 42 loads the game program, the image data, the sound data, etc. stored in the ROM 28a of the memory card 28 into the RAM 48, and executes the loaded game program. The CPU core 42 executes a game process while storing in the RAM 48 data (game data and flag data) temporarily generated in correspondence with a progress of the game.

It is noted that such the game program, the image data, the sound data, etc. are read from the ROM 28a entirely at a time, or partially and sequentially so as to be loaded into the RAM 48.

Each of the GPU 50 and the GPU 52 forms a part of a rendering means, is constructed by, for example, a single chip ASIC, and receives a graphics command (construction command) from the CPU core 42 to generate game image data according to the graphics command. However, the CPU core 42 applies to each of the GPU 50 and the GPU 52 an image generating program (included in the game program) necessary to generate the game image data in addition to the graphics command.

Furthermore, the GPU 50 is connected with a first video RAM (hereinafter, referred to as “VRAM”) 56, and the GPU 52 is connected with a second VRAM 58. Each of the GPU 50 and the GPU 52 gains access to the first VRAM 56 and the second VRAM 58 to fetch data (image data: data such as character, texture, etc.) required for executing a construction command by the GPU 50 and the GPU 52. It should be noted that the CPU core 42 writes the image data required for rendering into the first VRAM 56 and the second VRAM 58 via the GPU 50 and the CPU 52. The GPU 50 accesses the VRAM 56 to create the game image data for rendering, and accesses the VRAM 58 to create the game image data for rendering.

The VRAM 56 and the VRAM 58 are connected to the LCD controller 60. The LCD controller 60 includes a register 62, and the register 62 comprises, for example, one bit, and stores a value of “0” or “1” (data value) according to an instruction of the CPU core 42. The LCD controller 60 outputs the game image data created by the GPU 50 to the LCD 12, and outputs the game image data created by the GPU 52 to the LCD 14 in a case that the data value of the register 62 is “0”. Furthermore, the LCD controller 60 outputs the game image data created by the GPU 50 to the LCD 14, and outputs the game image data created by the GPU 52 to the LCD 12 in a case that the data value of the register 62 is “1”.

It is noted that, the LCD controller 60 directly reads the game image data from the VRAM 56 and VRAM 58, and reads the game image data via the GPU 50 and the GPU 52 from the VRAM 56 and the VRAM 58.

The I/F circuit 54 is connected with the operating switch 20, the touch panel 22 and the speaker 32. Here, the operating switch 20 is the above-described switches 20a, 20b, 20c, 20d, 20e, 20L and 20R, and in response to an operation of the operating switch 20, a corresponding operation signal (operation data) is input to the CPU core 42 via the I/F circuit 54. Furthermore, the coordinates data from the touch panel 22 is input to the CPU core 42 via the I/F circuit 54. In addition, the CPU core 42 reads-out the sound data necessary for the game such as a game music (BGM), a sound effect or voices of a game character (onomatopoeic sound), etc. from the RAM 48, and outputs it from the speaker 32 via the I/F circuit 54.

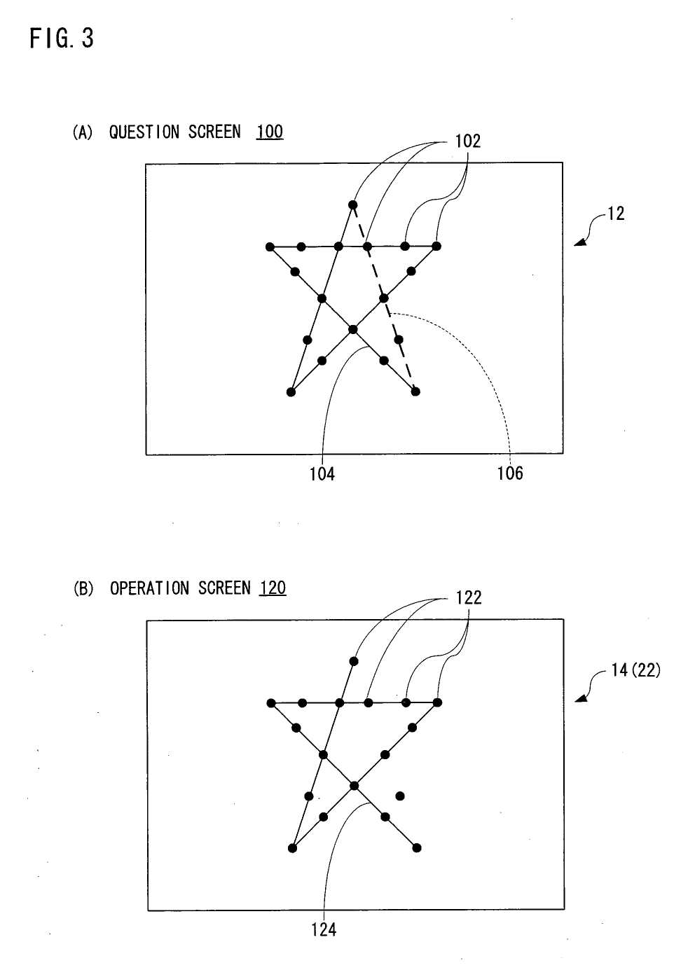

In the game apparatus 10 with such a configuration, a question screen 100 is displayed on the LCD 12 as shown in FIG. 3 (A), and an operation screen 120 is displayed on the LCD 14 as shown in FIG. 3 (B). With referring to the question screen 100, the player inputs on the operation screen 120 an answer to a question displayed on the question screen 100. The question screen 100 displays a plurality of objects (“points”) 102, and the plurality of points 102 are connected with connecting lines 104 or dotted lines 106. Since it is impossible to represent the drawings by color, the dotted line 106 is utilized for display in FIG. 3 (A), but this may be displayed by a solid line in a color different from the connecting line 104. On the other hand, the operation screen 120 displays a plurality of points 122 similarly to the question screen 100, and each of the plurality of points 122 except for a part of them are connected by the connecting line 124. As can be understood from a comparison between FIG. 3 (A) and FIG. 3 (B), the operation screen 120 shown in FIG. 3 (B) does not display the dotted lines 106 to be displayed on the question screen 100 shown in FIG. 3 (A).

In the virtual game (training game) of this embodiment, a player creates (answers) on the operation screen 120 a figure, etc. the same as the figure, symbols or characters (hereinafter, referred to be “figure”, etc.) displayed on the question screen 100. More specifically, the player makes a drag (sliding) operation on the operation screen 120 (touch panel 22) with the stick 24 so as to connect desired points 122.

When the player operates so as to connect two points 122, it is determined whether or not the two points 122 is to be connected (true or false determination). If the two points 122 are to be connected, it is determined that the player's operation is correct, and it is determined whether or not another points 122 to be connected exists. Here, if another point 122 to be connected exists, a true or false determination is repeated according to the drag operation by the player. However, if another point 122 to be connected dose not exist, it is determined that the figure, etc. the same as the figure, etc. displayed on the question screen 100 is displayed on the operation screen 120. That is, it is determined the answer to the question is “correct answer”, and the game is cleared. If it is determined that the two points 122 is not to be connected by the true or false determination, it is determined that the operation by the player is wrong, and “wrong answer” is determined to become a game over.

When the player makes a correct answer to the question, for example, if the question screen 100 and the operation screen 120 as to another question are successively displayed, the score is counted according to the number of correct answers, counts the number of correct answers within a fixed time, allowing the player to train for brain and a tip of a finger.

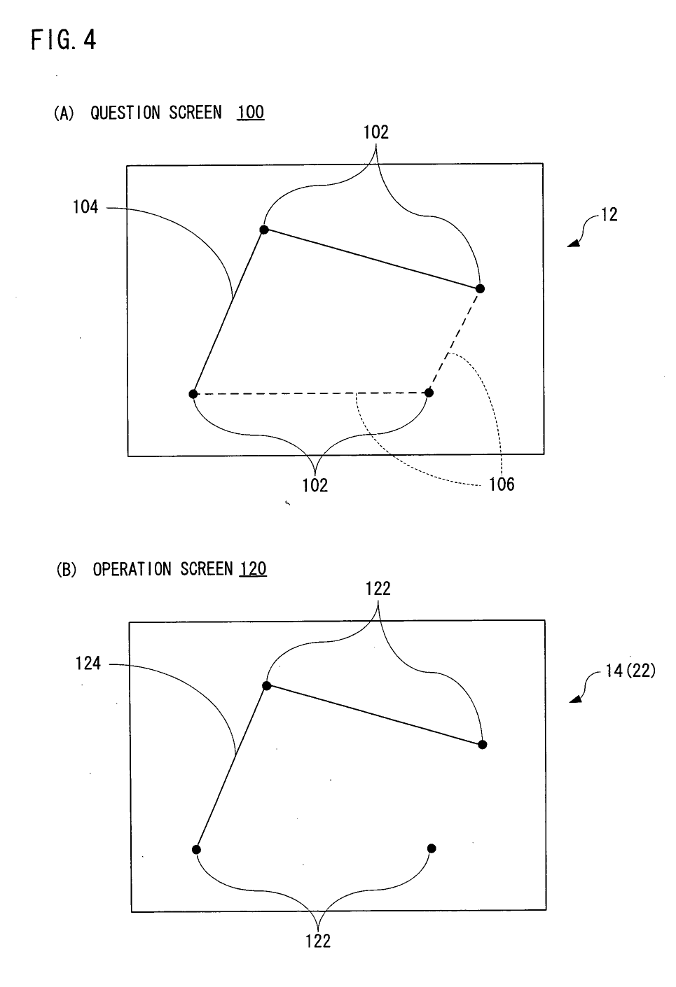

A detailed description of an operation and a display on the operation screen 120 will be made later. It is noted that for simplicity, a description is made on a case that the question screen 100 shown in FIG. 4 (A) is displayed on the LCD 12, and the operation screen 120 shown in FIG. 4 (B) is displayed on the LCD 14. More specifically, the question screen 100 displays a quadrangle figure in which four points 102 are connected by the connecting lines 104 and the dotted lines 106 as shown in FIG. 4 (A). Also, as shown in FIG. 4 (B), the operation screen 120 displays one in which the dotted lines 106 are erased from the figure displayed on the question screen 100.

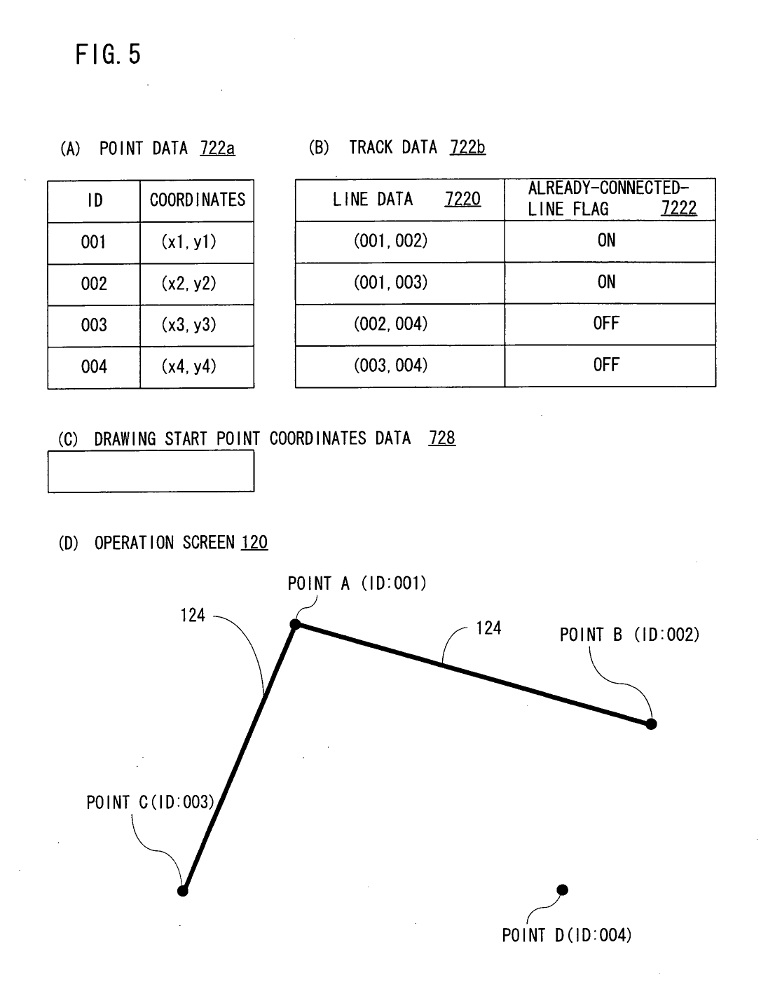

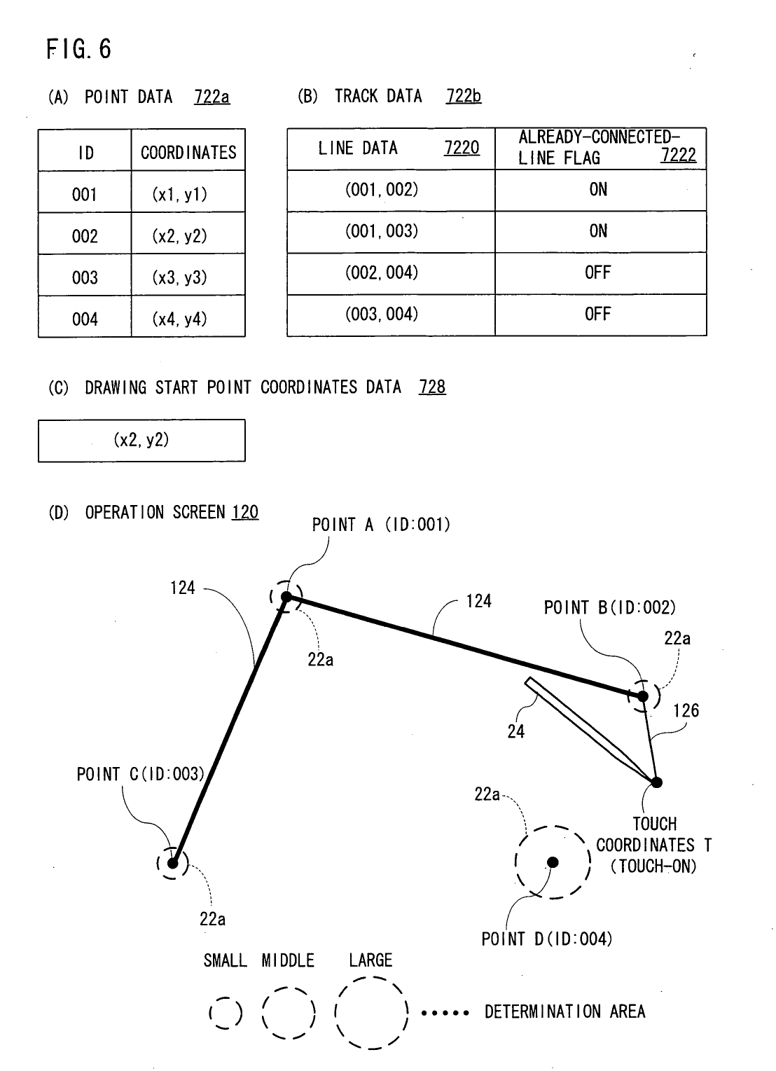

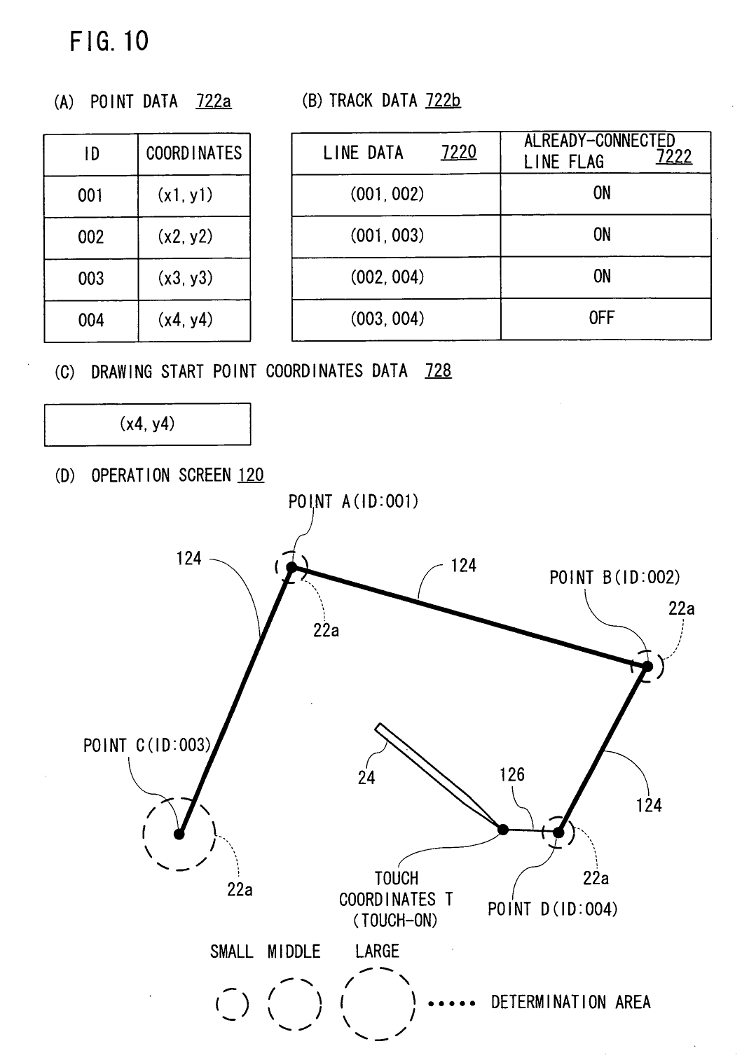

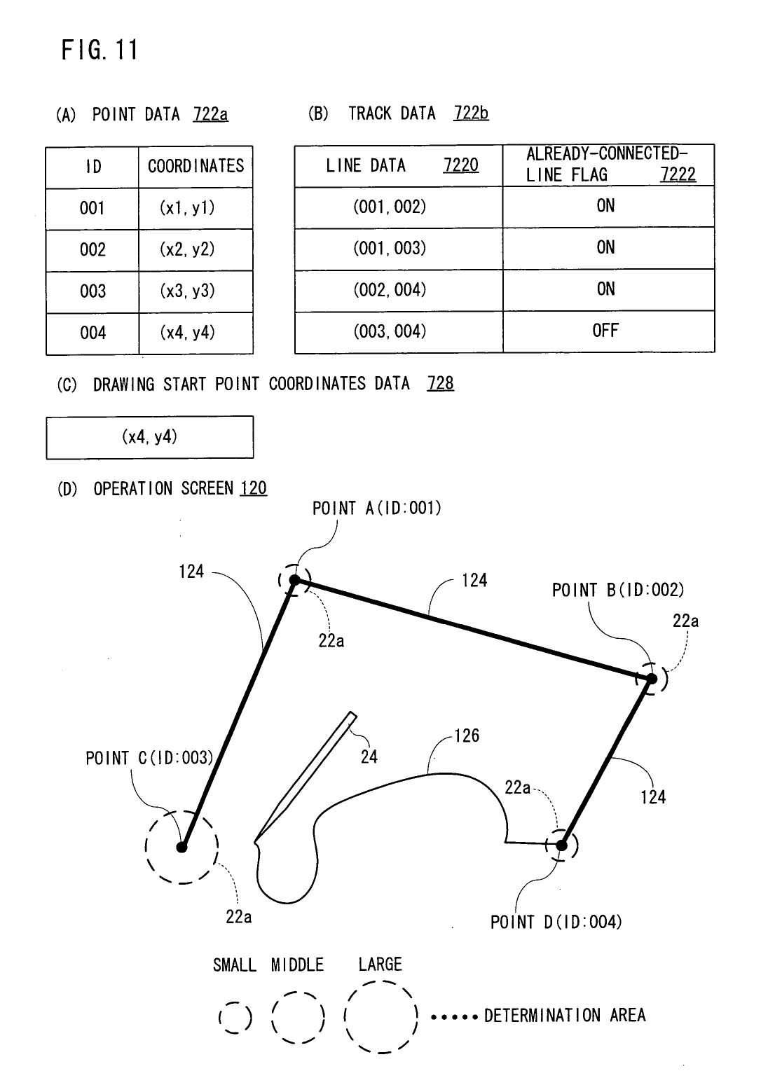

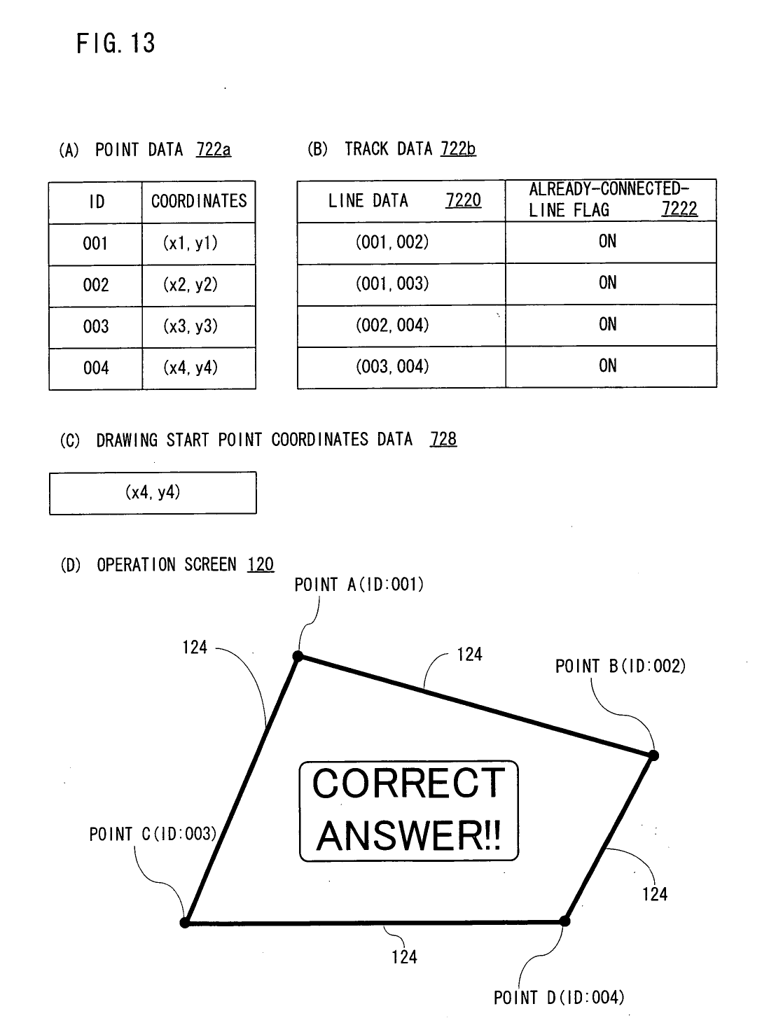

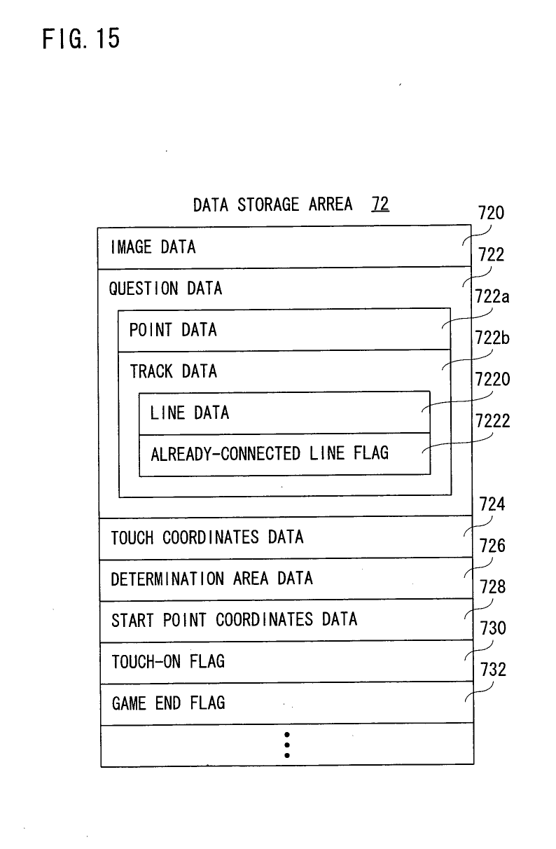

For example, initial screens of the question screen 100 and the operation screen 120 are displayed on the basis of point data 722a shown in FIG. 5 (A) and track data 722b shown in FIG. 5 (B). It is noted that the point data 722a, the track data 722b, line data 7220, an already-connected-line flag 7222, and start point coordinates data 728 shown in FIG. 5 (this is true for FIG. 6-FIG. 8, FIG. 10, FIG. 11 and FIG. 13) are stored in a data storage area 72 of the RAM 48 described later (see FIG. 15).

Here, the point data 722a and the track data 722b are data to display the question screen 100 and the operation screen 120, determine whether or not a true or false determination is made on the drag operation by the player, and determine whether or not the answer by the player is a correct. It is noted that since the display of the question screen 100 is not changed until the player makes a correct answer or a wrong answer to the question, the question screen is omitted in FIG. 5-FIG. 13.

As to the point data 722a, a position (coordinates) of the point 122 to be displayed on the operation screen 120 is shown in correspondence to identification information (ID number) of each point 122. Accordingly, the number of ID numbers or coordinates indicates the number of points 122. For example, as to the point data 722a, coordinates (x1, y1) is described in correspondence to the ID number “001”, coordinates (x2, y2) is described in correspondence to the ID number “002”, coordinates (x3, y3) is described in correspondence to the ID number “003”, and coordinates (x4, y4) is described in correspondence to the ID number “004”.

The track data 722b includes the line data 7220 and the already-connected-line flag 7222. The line data 7220 describes a plurality of a pair of ID numbers as to the two points 122 to be connected. Accordingly, when the points 122 corresponding to all the pair of ID numbers to be included in the line data 7220 are connected with each other, a figure, etc. the same as the figure, etc. displayed on the question screen 100 is created on the operation screen 120. That is, the answer to the question is a correct answer. The already-connected-line flag 7222 is a flag to determine whether or not the two points 122 to be connected has already been connected by the connecting line 124. If the already-connected-line flag 7222 is turned on, the two points 122 indicated by the pair of the ID numbers are connected by the connecting line 124. Conversely, if the already-connected-line flag 7222 is turned off, this shows that the two points 122 indicated by the pair of the ID number are not connected by the connecting line 124. In an example shown in FIG. 5 (B), the already-connected-line flag 7222 corresponding to pairs of ID numbers (001, 002) and (001, 003) are turned on, and the already-connected-line flag 7222 corresponding to pairs of ID numbers (002,004) and (003,004) are turned off.

It is noted that, as described above, on the question screen 100, the two points 122 indicated by the pair of ID numbers showing that the already-connected-line flag 7222 is turned off is connected by the dotted line 106.

The start point coordinates data 728 shown in FIG. 5 (C) is coordinates data as to a point 122 (hereinafter, referred to a “drawing start point”) to be instructed first in the case that the player performs a drag operation with the stick 24 to connect the points 122. At a start of displaying the operation screen 120, since the player does not start the drag operation, and the drawing start point is not determined, the start point coordinates data 728 is not described as shown in FIG. 5 (C).

It is noted that, although described later, when the player makes a drag operation, a line (drawing line 126) is displayed on the operation screen 120 according to the track of the drag operation.

In FIG. 5 (D), the operation screen 120 generated according to the above-described question data 722 (point data 722a and track data 722b) is shown. It is noted that in FIG. 5 (D) (this is true for FIG. 6-FIG. 13), characters of an alphabet A-D are utilized to display identification of each of the points 122. Here, a point 122 with the ID number of “001” is regarded as a point A, a point 122 with the ID number of “002” is regarded as a point B, a point 122 with the ID number of “003” is regarded as a point C, and a point 122 with the ID number of “004” is regarded as a point D. According to the above-described already-connected-line flag 7222, the point A and the point B are connected by a connecting line 124, and the point A and the point C are connected by a connecting line 124.

FIG. 6 (A)-FIG. 6 (D) show a state in which the player touches the screen utilizing the stick 24. Here, when the player touches, a point 122 as a starting point (drawing start point) of the drag operation is determined according to a touch position (touch coordinates). In this embodiment, it is determined that a point 122 of the coordinates closest to the touch coordinates T obtained in response to a touch by the player is instructed by the player, and the point 122 is determined as a drawing start point. In an example of the operation screen 120 shown in FIG. 6 (D), the point B is determined as a drawing start point. Accordingly, as shown in FIG. 6 (C), the coordinates (x2, y2) of the point B is stored as a start point coordinates data 728. Also as can be understood from FIG. 6 (D), when the drawing start point is determined, a connecting line (drawing line 126) connecting the drawing start point and the touch coordinates T is displayed. This is because that even in a case that the touch coordinates T and the drawing start point are not coincident with each other at a time of touching, it is considered that the player performs a drag operation from the drawing start point to the current touch coordinates T.

It is noted that only when a question is changed, the figure, etc. to be displayed on the operation screen 124 (this is true for the question screen 120) is changed, and therefore, the point data 722a and the line data 72220 are not changed. Also, the connecting line 124 is newly displayed from a state shown in FIG. 5 (D), so that the already-connected-line flag 7222 shown in FIG. 6 (B) is not also changed.

Additionally, when the drawing start point is determined, a determination area 22a is set in correspondence with each point 122 on the touch panel 22. The determination area 22a is an area to determine whether or not the player instructs the corresponding point 122. In this embodiment, the determination area 22a takes a form of circle centered on the coordinates of the corresponding point 122, and the size is set to three levels including “large” (10-dot diameter, for example), “middle” (7-dot diameter, for example), and “small” (3-dot diameter, for example) depending on the relationship between the drawing start point. For example, if the already-connected-line flag 7222 of the line data 7220 (pair of ID numbers) including the drawing start point is turned off, as to the point 122 to be connected to the drawing start point by the connecting line 124, the size of the determination area 22a is set to become “large”, and as to point 122 not to be connected to the drawing start point by the connecting line 124, the size of the determination area 22a is set to become “small”.

That is, when the drawing start point is determined, with reference to the line data 7220 showing that the already-connected-line flag 7222 is turned off, a pair of ID number as to the drawing start point is detected out of the pairs of ID numbers included in the line data 7220. Then, a determination area 22a of the point 122 of an ID number different from the ID number of the drawing start point included in the detected pair of ID numbers is set (changed) to become “large”, and the determination area 22a of the point 122 except for that is set (changed) to become “small”.

Thus, the reason why variably setting the determination area 22a is for making it easy to instruct (designate) the point 122 to be connected to the drawing start point, that is, the point to be instructed (designated) next to the drawing start point by a drag operation. Also, if a plurality of points 122 are displayed, this is also attributable to prevent the point 122 not to be designated next, that is, the point 122 not to be intended by the player from being erroneously designated. The advantage is prominent as the display area of the display portion (LCD 14 in this embodiment) of the operation screen 120 is narrower.

It is noted that although the determination area 22a of the point 122 to be designated next is made large, and determination area 22a of the point 122 not to be designated next is made small in this embodiment, it needs not to be limited thereto, merely enlarging at least the determination area 22a of the point 122 to be designated next enables a simple operation.

It is noted that if the already-connected-line flag 7222 of the line data 7220 including a drawing start point is turned on, that is, if the point 122 to be to be connected to the drawing start point does not exist, the size of the determination area 22a as to all the points 122 are set to become “middle (normal)”.

It is noted that, in this embodiment, setting a determination area 22a as to each point 122 is made when the drawing start point is determined. However, as shown in FIG. 5 (D), if the determination area 22a as to each point 122 is set to be the size of “middle” when the operation screen 120 is displayed, the size of the determination area 22a of each point 122 is changed on the basis of the relationship with the drawing start point when the drawing start point is determined.

More specifically, as shown in FIG. 6 (C) and FIG. 6 (D), when the drawing start point is set to become the point B, as shown in FIG. 6 (B), one pair of ID numbers including the ID number of the point B out of the line data 7220 showing that the already-connected-line flag 7222 is turned off exists in the line data 7220, and the determination area 22a of the point D corresponding to the ID number “004” except for the ID number “002” corresponding to the point B out of the pair of the ID numbers is set to become “large”. Then, the determination areas 22a of the point A, point B and point C except for that of the point D are set to become “small”.

Although illustration is omitted, in the initialization state shown in FIG. 5 (D), if the point C is determined as a drawing start point also, the determination area 22a of the point D is set to become “large”, and the determination areas 22a of the point A, point B and point C are set to become “small”. In addition, in the initialization state shown in FIG. 5 (D), if the point D is determined as a drawing start point, the determination areas 22a of the point B and point C are set to become “large”, and the determination areas 22a of the point A and the point D are set to become “small”.

It is noted that since the determination area 22a is set to the touch panel 22 in this embodiment, with referring to the coordinates data from the touch panel 22, it is easily detect the fact that the touch coordinates T contacts or is included in the determination area 22a. Also, since the resolution of the LCD 14 and the detection accuracy of the touch panel 22 are made to be the same in this embodiment as described above, the determination area 22a may be set with respect to the LCD 14. In such a case, if the coordinates system of the LCD 14 and the coordinates system of the touch panel 22 are coincident with each other, by referring to the coordinates data from the touch panel 22, it is possible to easily detect the fact that the touch coordinates T contacts or is included in the determination area 22a set to the LCD 14.

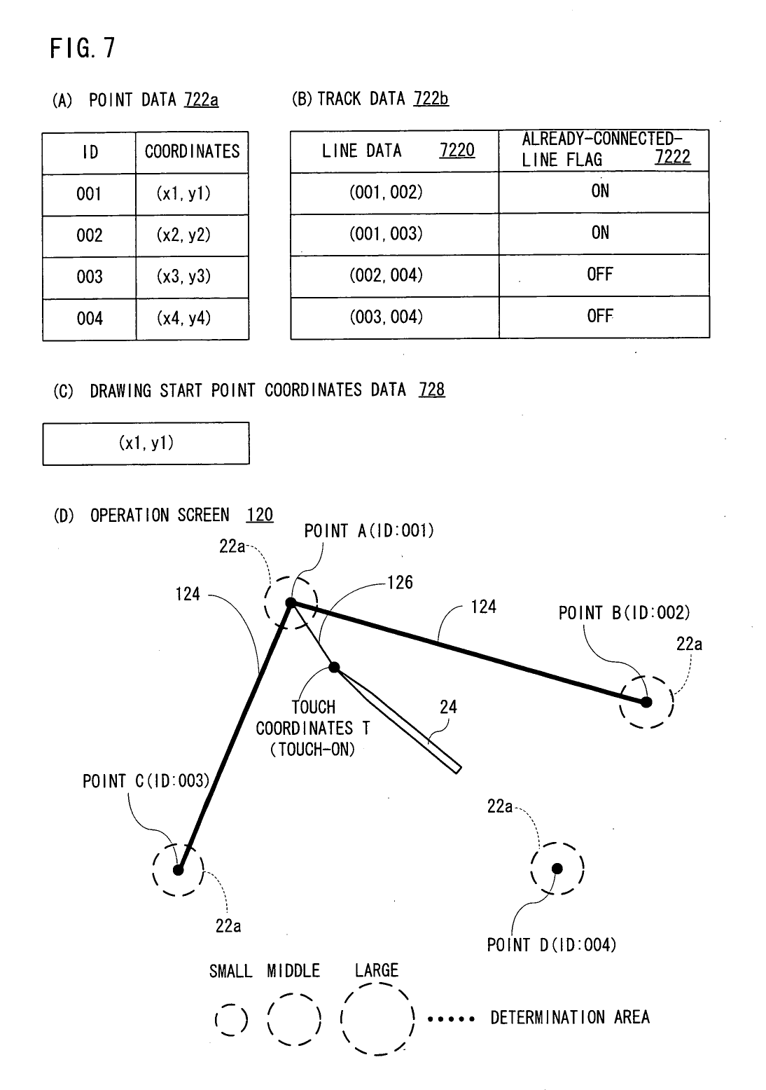

It is noted that as shown in FIG. 7 (A)-FIG. 7 (D), if the position touched by the player is the nearest to the point A, the point A is determined as the drawing start point, and the coordinates (x1, y1) data of the point A is described as the start point coordinates data 728 as shown in FIG. 7 (C). It is noted that since the connecting line 124 is not newly displayed from a state shown in FIG. 5 (D), the already-connected-line flag 7222 shown in FIG. 7 (B) is not changed.

Thus, if the point A is determined as the drawing start point, the already-connected-line flag 7222 corresponding to the pairs of ID numbers including the ID number of the point A are all turned on, and all the sizes of the determination areas 22a of the point A to the point D are determined to be “middle”. This is because that as described above, no point 122 to be connected to the drawing start point exists, and the relationship for making the determination area 22a “large” and “small” is not established.

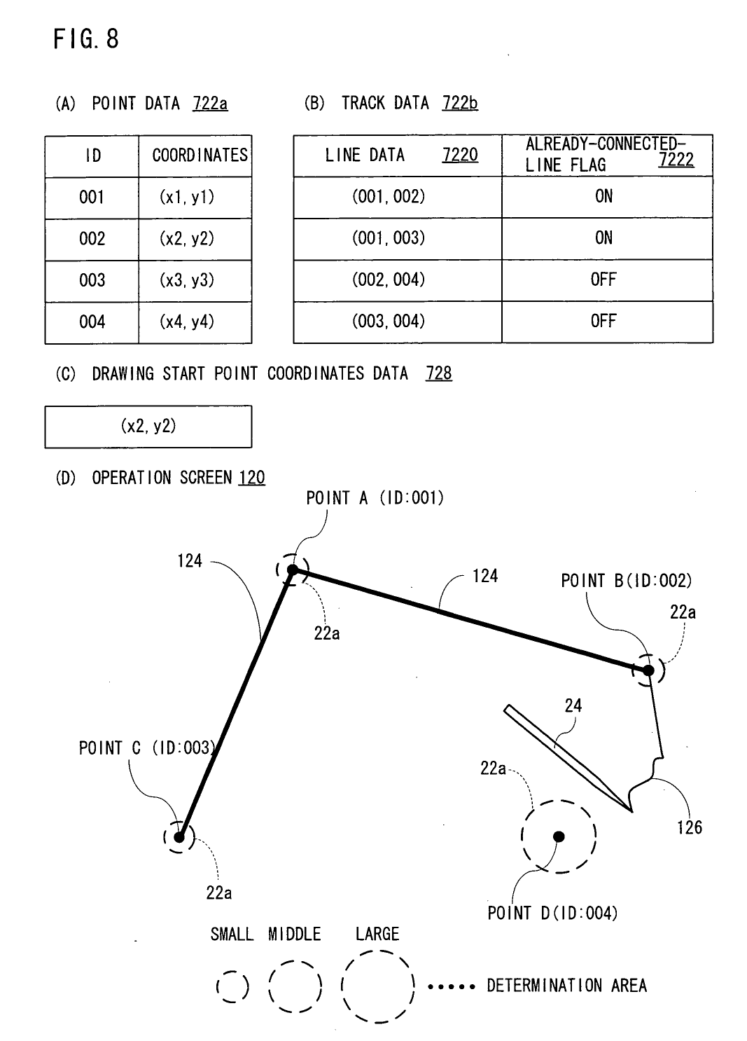

FIG. 8 (A)-FIG. 8 (D) show a state in which the point B is determined as a drawing start point as shown in FIG. 6 (A)-FIG. 6 (D), and the player successively makes a drag operation. As understood from FIG. 8 (D), the drawing line 126 is displayed according to the drag operation by the player. It is noted that since the drawing start point is not changed, and the connecting line 124 is not newly displayed, the already-connected-line flag 7222 and the start point coordinates data 728 are not changed.

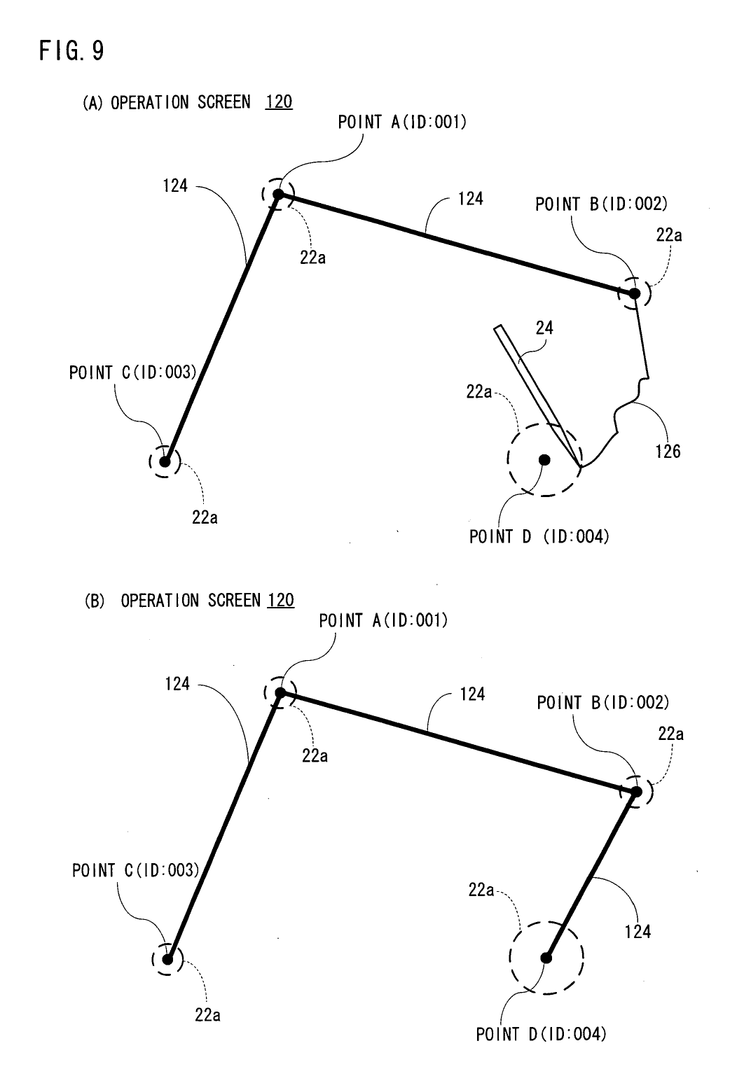

FIG. 9 (A) shows a state in which the player further makes a drag operation from the state shown in FIG. 8(D) to make the touch coordinates T contact or be included in the determination area 22a of the point D. At this time, it is determined that the drawing start point (point B) and the point D are connected with each other. If the point B and the point D are connected with each other, the drawing line 126 drawn between the point B and the point D is erased, and the connecting line 124 is alternatively displayed such that the point B and the point D are connected by the straight line as shown in FIG. 9 (B).

Here, as shown in FIG. 8 (B), since as to the track data 722b, the already-connected-line flag 7222 corresponding to the pair of ID numbers (002, 004) included in the line data 7220 is turned off, it is determined that the two points 122 to be connected are connected with each other. That is, it is determined that the point B and the point D are correctly connected with each other. Thereafter, the already-connected-line flag 7222 corresponding to the pair of ID numbers (002,004) is turned on (see FIG. 10 (B)).

FIG. 10 (A)-FIG. 10 (D) show a state in which the point B and the point D are connected, and then, the point D is determined as a next drawing start point. Although illustration is omitted, if the player performs a drag operation so as to connect the point B and the point D, and then temporarily performs a touch-off operation, as shown in FIG. 10 (D), by a touch-on operation, the point 122 having the shortest distance with the touch coordinates T is determined as a drawing start point. It is noted that if the player performs a drag operation so as to connect the point B and the point D, and then continues to perform the drag operation without a touch-off operation, an end point corresponding to the drawing start point directly before is determined as a next drawing start point without calculating the distance between the touch coordinates T and each point 122. Accordingly, if a drag operation is continued in a state shown in FIG. 9 (A) without a touch-off operation as shown in FIG. 10(D), the point D is determined as a next drawing start point.

Additionally, when the next drawing start point is determined, the determination area 22a of each point 122 is set (changed). In an example shown in FIG. 10 (C) and FIG. 10 (D), the drawing start point is the point D, and as shown in FIG. 10(B), the pair of ID numbers included in the line data 7220 showing that the already-connected-line flag 7222 is turned off includes the ID number of the point D. Accordingly, the determination area 22a of the point C corresponding to the ID number “003” except for the ID number “004” of the point D in the pair of ID numbers is set (changed) to “large”. Then, the determination areas 22a of the point A, the point B, and the point D except for that of the point C are set to “small”.

It is noted that FIG. 10 (B) shows that the connecting line 124 is displayed between the point B and the point D as shown in FIG. 9 (B), and the corresponding already-connected-line flag 7222 is turned on.

FIG. 11 (A)-FIG. 11 (D) show that the player performs a touch-on operation with the stick 24, and continues to perform a drag operation after the drawing start point (point D) is determined as shown in FIG. 10 (A)-FIG. 10 (D). It is noted that since the drawing start point remains to be the point D, and another connecting line 124 is not displayed, the already-connected-line flag 7222 and the drawing start point coordinates data 728 are not changed.

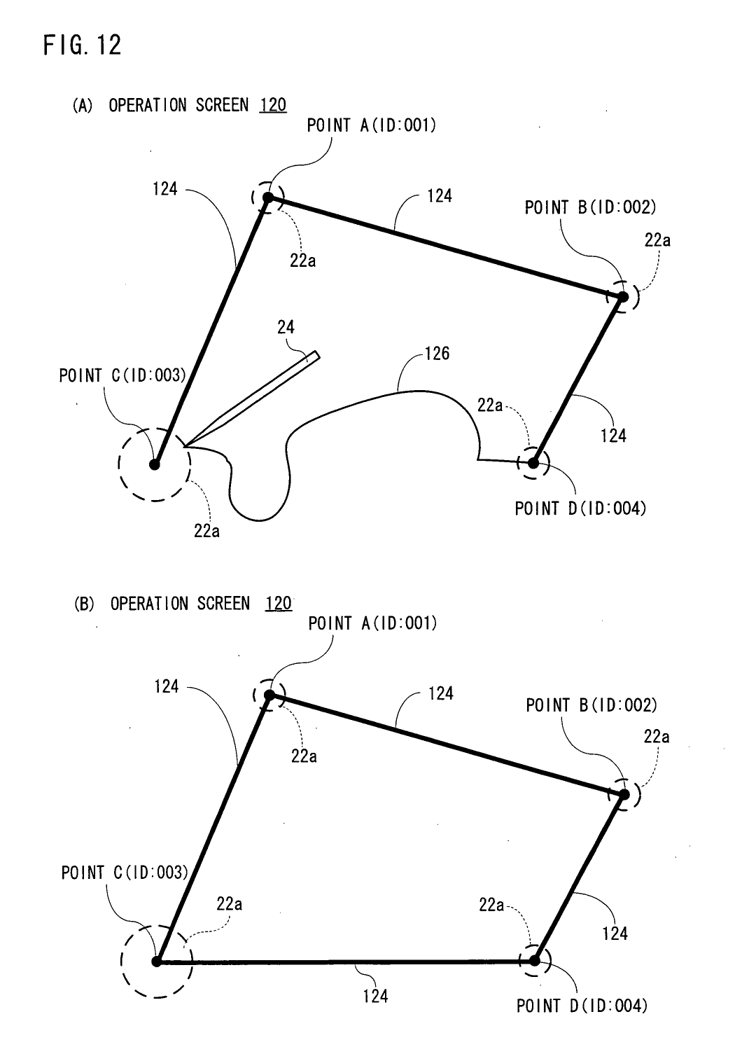

FIG. 12 (A) shows that a drag operation is further performed from a state shown in FIG. 11 (D), and the touch coordinates T contacts or is included in the determination area 22a of the point C. At this time, it is determined the drawing start point (point D) and the point C are connected with each other. When the point D and the point C are connected with each other, the drawing line 126 drawn between the point D and the point C is erased, and the connecting line 124 is displayed so as to connecting the point D and the point C with a straight line as shown in FIG. 12(B).

Here, as shown in FIG. 11 (B), as to the track data 722b, the already-connected-line flag 7222 corresponding to the pair of ID numbers (003, 004) included in the line data 7220 is turned off, so that it is determined that the two points 122 to be connected are connected. That is, it is determined that the point D and the point C are correctly connected. Then, the already-connected-line flag 7222 corresponding to the pair of ID numbers (003, 004) is turned on (see FIG. 13(B)).

Thus, when the already-connected-line flag 7222 corresponding to the pair of ID numbers (003, 004) included in the line data 7220 is turned on, all the already-connected-line flags 7222 included in the track data 722b are turned on as shown in FIG. 13 (B). At this time, it is determined that a figure, etc. the same as the figure, etc. of the questions is displayed (drawn) on the operation screen 120, the character of “correct answer (clear)” is displayed on the operation screen 120 as shown in FIG. 13(D).

It is noted that although illustration is omitted, if the points 122 of pair of ID numbers which is not present in the line data 7220 are connected with each other, the two points 122 to be connected are not connected, so that the character of “wrong answer (game over)” is displayed on the operation screen 120.

It is noted that the points 122 of the pair of ID numbers showing that the already-connected-line flag 7222 has already been turned on are connected with each other, the starting point is changed.

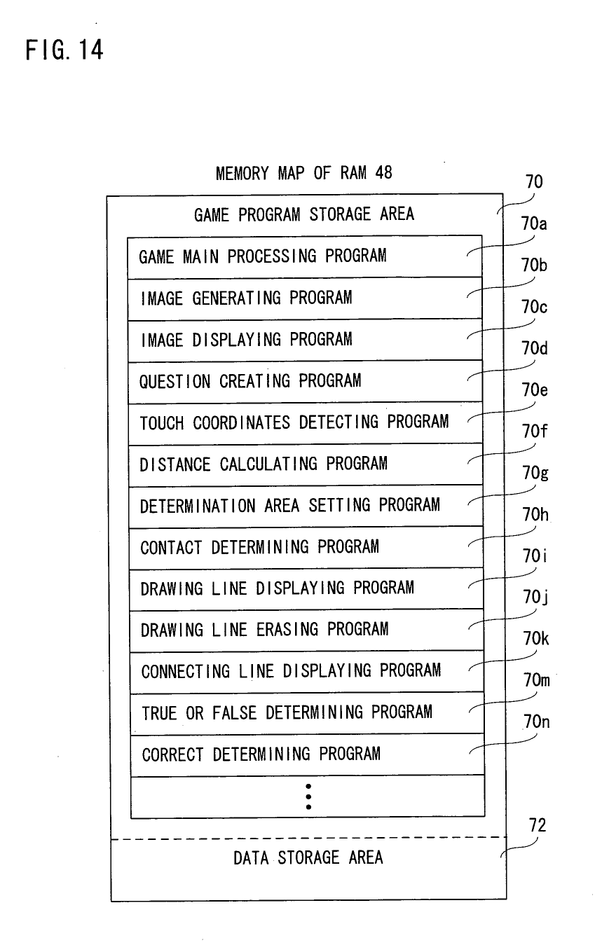

FIG. 14 shows a memory map of a RAM 48 in FIG. 2. Referring to FIG. 14, the RAM 48 includes a game program storage area 70 and a data storage area 72. In the game program storage area 70, a game program (training program) of the embodiment is stored, and the game program (training program) includes a game main processing program 70a, an image generating program 70b, an image displaying program 70c, a question creating program 70d, a touch coordinates detecting program 70e, a distance calculating program 70f, a determination area setting program 70g, a contact determining program 70h, a drawing line displaying program 70i, a drawing line erasing program 70j, a connecting line displaying program 70k, a true or false determining program 70m, a correct determining program 70n, etc.

The game main processing program 70a is a program to process a main routine of the training game of this embodiment. The image generating program 70b is a program for generating an image (object) to display the question screen 100 and the operation screen 120 as shown in FIG. 3-FIG. 13 by use of the image data 720 described later. The image displaying program 70c is a program for displaying an image (question screen 100 and operation screen 120) generated according to the image generating program 70b.

The question creating program 70d is a program to create questions in the training game. In brief, a question to be displayed on the question screen 100 is created by use of question data 722 described later. For example, the point data 722a and the line data 7220 included in the question data 722 are read to determine whether or not the already-connected-line flag 7222 (see FIG. 15) to be set for each line data 7220 is turned on or off at random. The more the number of the already-connected-line flag 7222 is turned off, the more the number of the connecting lines 124 to be connected through an operation by the player is, the higher the difficulty level of the game is, thus it may be possible that the number of the times of turning-off the already-connected-line flag 7222 is decided according to the level of the player. When the turn on or off of the already-connected-line flag 7222 is determined, the track data 722b shown in FIG. 5 (B) is generated, the points 102 are arranged according to the point data 722a shown in FIG. 5(A), and the connecting line 104 and the dotted line 106 are arranged according to the track data 722b. That is, the points 102 corresponding to the pair of ID numbers showing that the already-connected-line flag 7222 is turned on are connected by the connecting line 104, and the points 102 corresponding to the pair of ID numbers showing that the already-connected-line flag 7222 is turned off are connected by the dotted line 106. Thus, a question (question screen 100) is generated.

It is noted that the image generating program 70b generates an operation screen 120 by utilizing the question screen 100 created according to the question creating program 70d. More specifically, a method of creating the operation screen 120 is the same as that of the question screen 100 except for that the points 102 corresponding to the pair of ID numbers showing that the already-connected-line flag 7222 is turned off are never connected with each other.

The touch coordinates detecting program 70e is a program to detect the coordinates data to be output from the touch panel 22. Also, if the touch coordinates T is detected according to the touch coordinates detecting program 70e, the CPU core 42 establishes (turns on) a touch-on flag 730 described later. On the other hand, if the touch coordinates T is not detected according to the touch coordinates detecting program 70e, the CPU core 42 does not establish (turns off) the touch-on flag 730.

The distance calculating program 70f is a program to calculate the distance between the touch coordinates T and each point 122. The determination area setting program 70g sets a determination area 22a of each point 122 depending on a relationship with the drawing start point when the drawing start point is determined. The setting method of the determination area 22a is as described above. The contact determining program 70h is a program to determine whether or not the touch coordinates T touches or is included in any of the determination areas 22a. More specifically, it is determined whether or not the touch coordinates T corresponding to the coordinates data from the touch panel 22 is included in the determination area 22a.

The drawing line displaying program 70i is a program to represent the track of the drag operation by the player by the drawing line 126. It is noted that as described above, if the touch coordinates T when the player touches the screen with the stick 24 is apart from a point 122 as a drawing start point, the touch coordinates T and the drawing start point are connected by a straight line. The drawing line erasing program 70j is a program to erase a drawing line 126 which has been displayed (drawn) when the touch coordinates T touches or is included in a determination area 22a of any of the points 122 according to the contact determining program 70h.

It is noted that, although illustration is omitted, the CPU core 42 determines to restart a drag operation if the player performs a touch-off operation the touch panel before the touch coordinates T contacts or is included in any of the determination areas 22a. In such a case, the CPU core 42 erases the drawing line 126 by executing the drawing line erasing program 70j, and resets the drawing start point coordinates data 728.

The connecting line displaying program 70k is a program, when it is determined that the touch coordinates T touches or is included in a determination areas 22a of any one of the points 122 by the contact determining program 70h, and the point 122 corresponding to the determination area 22a is except for the drawing start point, to connect the drawing start point and the point 122 by the connecting line 124. The true or false determining program 70m is a program, when it is determined that the touch coordinates T touches or is included in a determination area 22a of any one of the points 122 by the contact determining program 70h, to determine whether or not the drawing start point and the point 122 are the two points 122 to be connected. Also, the true or false determining program 70m turns on the already-connected-line flag 7222 in corresponding to the pair (pair of ID numbers) if it is determined that the two points 122 are to be connected. On the other hand, the true or false determining program 70m turns a game end flag 732 on if it is determined that the two points 122 are not to be connected.

The correct determining program 70n is a program to determine whether or not an answer from the player is a correct. That is, it is determined whether or not a figure, etc. the same as the figures, etc. displayed on the question screen 100 is displayed on the operation screen 120. More specifically, it is determined whether or not all of the already-connected-line flags 7222 to be included in the track data 722b are turned on. Then, if all of the already-connected-line flags 7222 included in the track data 722b are turned on, it is determined that the answer to the question is a correct.

Although illustration is omitted, in the game program storage area 70, a sound output program, a backup program, etc. are stored. The sound output program is a program to output a sound necessary for the training game of the embodiment such as the music (BGM), voices or onomatopoeic sounds of game characters, a sound effect, and the like. The backup program is a program to store (save) the game data (proceeding data, result data) in the RAM 28b of the memory card 28 in response to an instruction from the player, or according to a predetermined event.

FIG. 15 is an illustrative view showing a detailed example of the data storage area 72 shown in FIG. 14. In the data storage area 72, the image data 720, the question data 722, the touch coordinates data 724, the determination area data 726, and the start point coordinates data 728, etc. are stored.

The image data 720 is data (polygon data and the texture data) to generate the question screen 100 and the operation screen 120. The question data 722 is data to be referred when a question (question screen 100) is created. The question data 722 comprises the point data 722a and the track data 722b, for example. For simplicity, only one question data 722 is shown in this embodiment. However, actually, a plurality of question data are stored, one question data is selected according to a predetermined rule (in order or at random), and the question screen 100 and the operation screen 120 according to the selected question data are generated and displayed.

The point data 722a is data to which the coordinates corresponding to the ID number assigned to each point 122 is written as described above. As described above, the track data 722b includes the line data 7220 and the already-connected-line flag 7222. The line data 7220 is data to which a plurality of a pair of ID numbers of the two points 122 to be connected are written. Also, the already-connected-line flag 7222 is a flag to determine whether or not the points 122 indicated by the pair of ID numbers included in the line data 7220 are connected with each other as described above. In other words, the already-connected-line flag 7222 is a flag to determine whether or not the connecting line 124 connecting the points 122 indicated by the pair of ID numbers is displayed. The already-connected-line flag 7222 comprises one bit register, for example, and the register stores a data value “1” if the flag is turned on. If the flag is turned off, the register stores a data value “0”. It is noted that the already-connected-line flag 7222 is turned on in a case that the points 122 having the ID numbers included in the line data 7220 are connected by the connecting line 124, and the already-connected-line flag 7222 is turned off in the case that the points 122 having the ID numbers included in the line data 7220 are not connected by the connecting line 124.

The touch coordinates data 724 is to store the coordinates data of the touch coordinates T input from the touch panel 22 on the time series. Accordingly, the above-described drawing line displaying program 70h displays (draws) a drawing line 126 on the basis of these touch coordinates T. The contact determining program 70h determines whether or not the latest (current) touch coordinates T contacts or is included in the determination area 22a.

The determination area data 726 is data as to the determination area 22a which is set or changed according to the above-described determination area setting program 70g. For example, as described above, the determination area 22a has a circle shape, and the numerical value data of the radius (the number of dots) is described in correspondence with each point 122 or each ID number. It is noted that coordinates data as to all the dots included in the determination area 22a may be stored, resulting in a waste of a memory capacity. Alternatively, if the determination area 22a takes another shape (quadrilateral shape, for example), the coordinates data of the specific point (apex) may be stored.

The start point coordinates data 728 is coordinates data as to the point 122 which is determined to be a drawing start point if the player starts to draw a drawing line 126. In this embodiment, the drawing start point is determined when the player touches the touch panel 22 with the use of the stick 24, or when the player performs a drag operation after connecting the points 122 without a touch-off operation.

Also, the data storage area 72 is provided with flags such as the touch-on flag 730 and the game end flag 732. The touch-on flag 730 is a flag to determine whether or not the player performs a touch operation. The touch-on flag 730 also comprises one bit register, and the register stores a data value “1” when the flag is turned on, and stores a data value “0” when the flag is turned off. It is noted that the touch-on flag 730 is turned on when the coordinates data from the touch panel 22 is present, and the touch-on flag 730 is turned off when the coordinates data from the touch panel 22 is not present.

The game end flag 732 is a flag to determine whether or not the game is to be ended. The game end flag 732 also comprises a one bit register, the register stores a data value “1” when the flag is turned on, and the register stores a data value “0” when the flag is turned off. It is noted that in the game end flag 732 is turned on when the game is cleared or the game is over, and the flag is turned off except for that this embodiment.

It is noted that although illustration is omitted, in the data storage area 72, other data and flags are also stored. For example, as other data, sound (music) data for generating a sound necessary for the training game is applicable. Also, as other flags, a flag to identify (determine) an aspect (question) of the game which is cleared by the player is applicable.

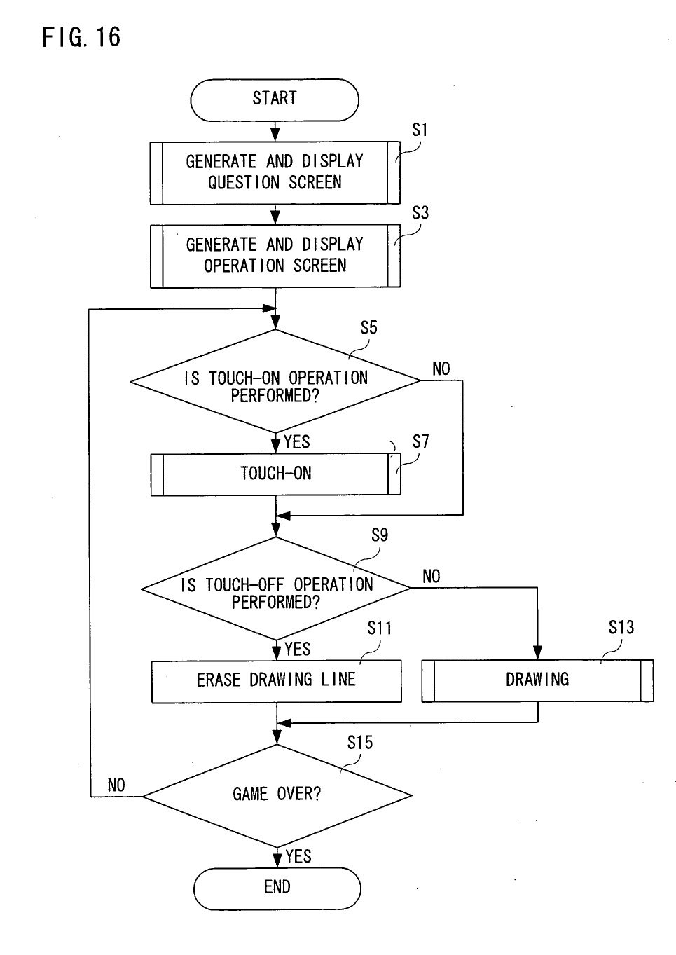

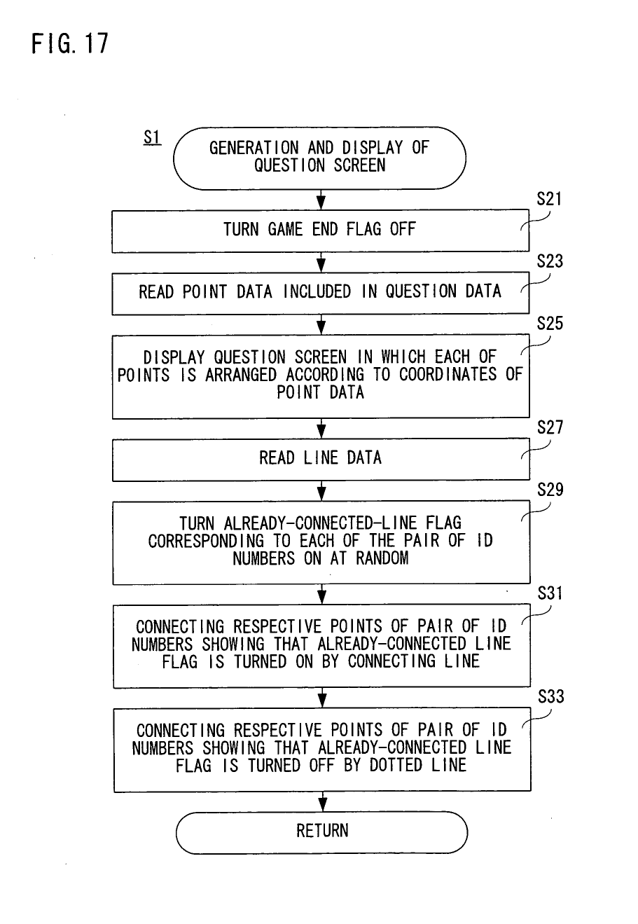

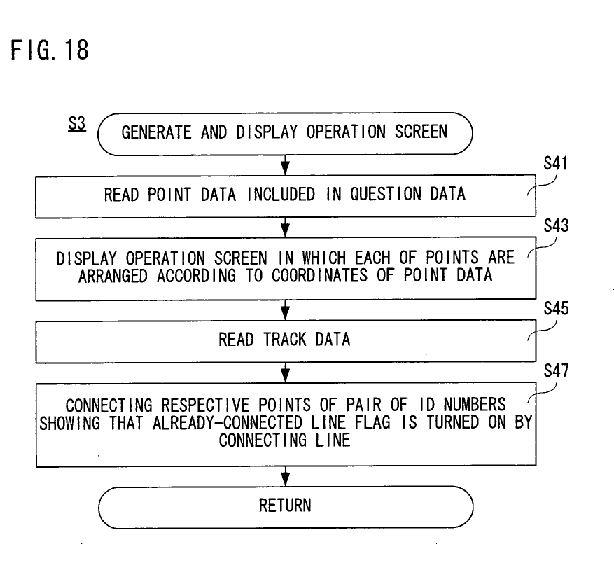

More specifically, the CPU core 42 shown in FIG. 2 executes a game entire process according to a flowchart shown in FIG. 16. As shown in FIG. 16, when starting a game entire process, the CPU core 42 executes a question screen generating and displaying process (see FIG. 17) in a step S1, and executes an operation screen generating and displaying process (see FIG. 18) in a step S3. In a next step S5, it is determined whether or not the touch-on operation is performed. More specifically, the CPU core 42 determines whether or not the touch-on flag 730 is turned from off to on.

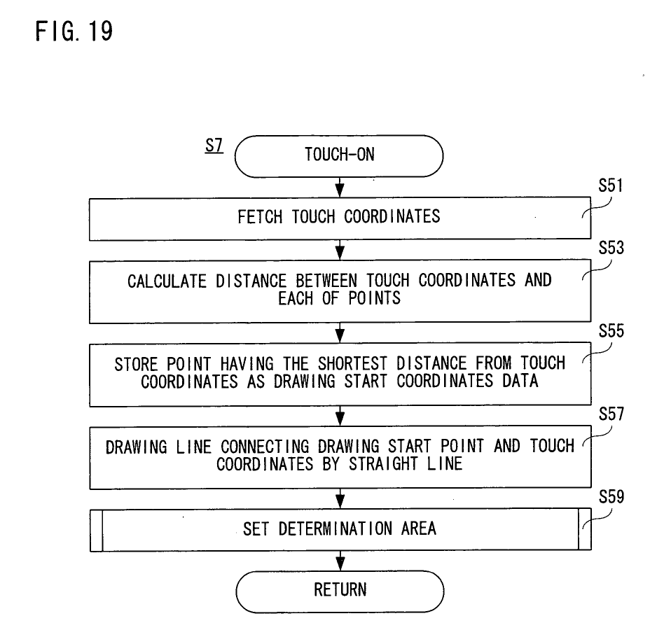

If “NO” in the step S5, that is, if the touch-on flag 730 remains to be turned on, or if the touch-on flag 730 is turned off, it is determined the touch-on operation is not performed, and then, the process directly proceeds to a step S9. On the other hand, if “YES” in the step S5, that is, if the touch-on flag 730 is turned from off to on, it is determined that the touch-on operation is performed, a touch-on process (see FIG. 19) is executed in a step S7, and then, the process proceeds to the step S9.

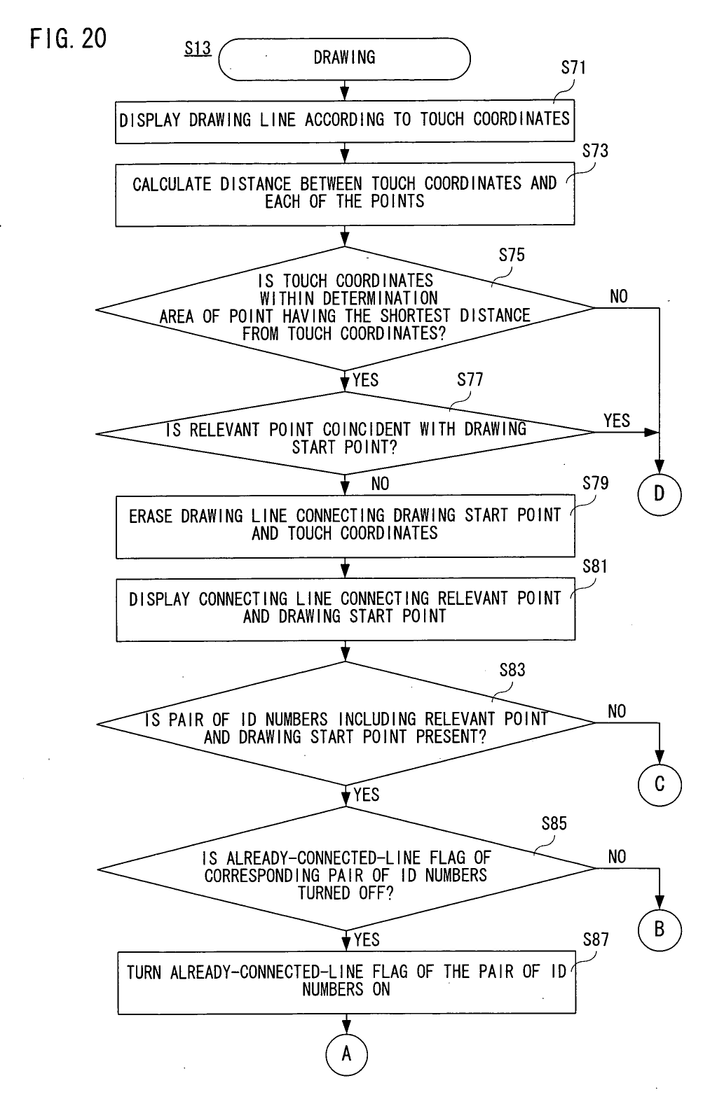

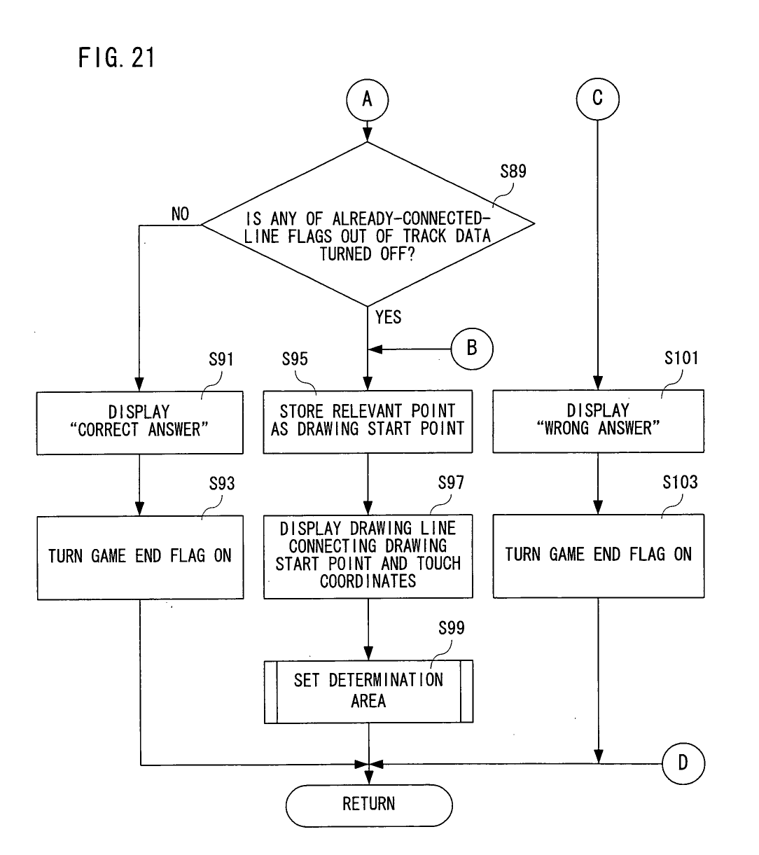

It is determined whether or not the touch-off operation is performed in the step S9. More specifically, the CPU core 42 determines whether or not the touch-on flag 730 is turned from on to off. If “YES” in the step S9, that is, if the touch-on flag 730 is turned from on to off, it is determined that a touch-off operation is performed, the drawing line 126 is erased in a step S11, and then, the process proceeds to a step S15. On the other hand, if “NO” in the step S9, that is, if the touch-on flag 730 remains to be turned off, or if the touch-on flag 730 is turned on, it is determined that a touch-off operation is not performed, a drawing process (FIG. 20 and see FIG. 21) is executed in a step S13, and then, the process proceeds to the step S15.

In the step S15, it is determined whether or not the game is to be ended. Here, the CPU core 42 determines whether or not an instruction for the game end from the player is present, or whether or not the game end flag 732 is turned. If “NO” in the step S15, that is, if the game is not to be ended, the process directly returns to the step S5. However, if “YES” in the step S15, that is, if the game is to be ended, a game entire process is ended.

It is noted that as described later, even in a case that a correct answer is given to the question, the game is ended in this embodiment, but a next question may be created to continue the game.

FIG. 17 is a flowchart showing a question screen generating and displaying process in the step S1 shown in FIG. 16. Referring to FIG. 17, when starting the question screen generating and displaying process, the CPU core 42 turns the game end flag 732 off in a step S21. In a next step S23, the point data 722a included in the question data 722 is read. It is noted that in a case that a plurality of question data are stored as described above, one question data is selected according to a predetermined rule, and the point data 722a included in the selected one question data is read. Then, in a step S25, a question screen 100 on which each of points 122 is arranged according to the coordinates of the point data 722a is displayed on the LCD 12.

Successively, in a step S27, the line data 7220 included in the question data 722 is read, and the already-connected-line flag 7222 corresponding to each of the pair of ID numbers included in the line data 7220 is turned on at random in a step S29. Then, in a step S31, the respective points 102 which are indicated by the pair of ID numbers showing that the already-connected-line flag 7222 is turned on are connected by the connecting line 104. That is, the connecting line 104 connecting the points 102 of the pair of ID numbers showing that the already-connected-line flag 7222 is turned on is displayed on the question screen 100. Then, in a step S33, the dotted line 106 connecting the points 102 of the pair of ID numbers showing that the already-connected-line flag 722 is turned off is displayed on the question screen 100, and then, the question screen generating and displaying process is returned.

It is noted that although the question generating process shown in FIG. 17 is omitted for simplicity, it my be possible that the number of the turn-on of the already-connected-line flag 7222 is determined depending on the level of the player as described above.

FIG. 18 is a flowchart showing an operation screen generating and displaying process shown in the step S3 in FIG. 16. As shown in FIG. 18, when starting the operation screen generating and displaying process, the CPU core 42 reads the point data 722a included in the question data 722 in a step S41. It is noted that in the question screen generating and displaying process, in a case of selecting one question data from a plurality of question data as described above, the point data 722a included in the selected one question data is read.

In a succeeding step S43, an operation screen 120 on which each of the points 122 is arranged according to the coordinates of the point data 722a is displayed on the LCD 14. In a next step S45, the track data 722b is read. Then, in a step S47, the respective points 122 having the pair of ID numbers showing that the already-connected-line flag 7222 is turned on are connected by the connecting line 124, and then, the operation screen generating and displaying process is returned. That is, in the step S47, the connecting line 124 connecting the points 122 of the pair of ID numbers showing that the already-connected-line flag 7222 is turned on is displayed on the operation screen 120.

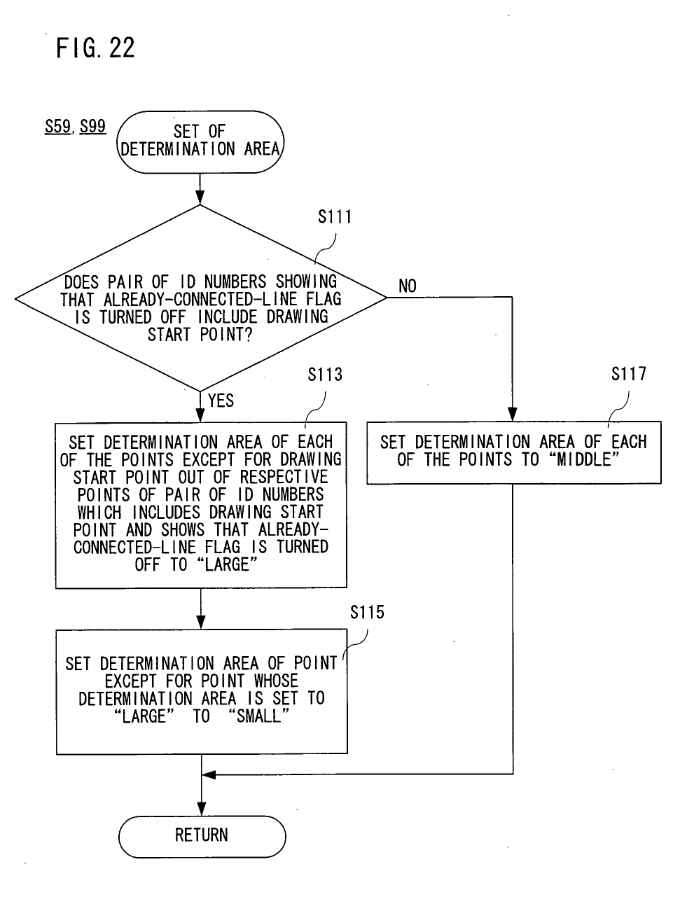

FIG. 19 is a flowchart showing a touch-on process in the step S7 shown in FIG. 16. As shown in FIG. 19, when starting the touch-on process, the CPU core 42 fetches touch coordinates T in a step S51. That is, the CPU core 42 detects coordinates data input from the touch panel 22, and stores the detected coordinates data (touch coordinates data) in the data storage area 72 of the RAM 48 on the time series. In a succeeding step S53, a distance between the fetched touch coordinates T and each point 122 is calculated. Successively, in a step S55, a point 122 having the shortest distance from the touch coordinates T is determined as a drawing start point, and coordinates data of the drawing start point (start point coordinates data 728) is stored in the data storage area 72 of the RAM 48. Next, in a step S57, the straight line (drawing line 126) connecting the drawing start point and the touch coordinates T is drawn (displayed) on the operation screen 120. Then, in a step S59, a determination area setting process (see FIG. 22) is executed and then, the touch-on process is returned.

It is noted that although a detailed description is omitted, in the touch-on process shown in FIG. 19, the starting point coordinates and the touch coordinates T are sure to be connected by the straight line in the step S57. However, if the starting point coordinates and the touch coordinates T are coincident with each other, the process is not needed.

FIG. 20 and FIG. 21 is a flowchart showing a drawing process in the step S13 in FIG. 16. As shown in FIG. 20, when starting the drawing process, the CPU core 42 displays a drawing line 126 according to the touch coordinates T in a step S71. Here, the CPU core 42 displays the drawing line 126 such that the detected touch coordinates T are connected to the each of the points 122 by the straight line on the time series. In a succeeding step S73, the distance between the touch coordinates T and each of the points 122 is calculated.

Successively, in a step S75, it is determined whether or not the touch coordinates T is within the determination area 22a of a point 122 having the shortest distance from the touch coordinates T. That is, the CPU core 42 specifies the point 122 having the shortest distance from the touch coordinates T on the basis of the distance calculated in the step S73, and determines whether or not the touch coordinates T contacts or is included in the determination area 22a of the point 122. If “NO” in the step S75, that is, if the touch coordinates T is not within the determination area 22a of the point 122 having the shortest distance from the touch coordinates T, the drawing process is directly returned as shown in FIG. 21. On the other hand, if “YES” in the step S75, that is, if the touch coordinates T is within the determination area 22a of the point 122 (hereinafter, referred to as “the relevant point 122”) having the shortest distance from the touch coordinates T, it is determined whether or not the relevant point 122 and the drawing start point are coincident with each other in a step S77.

If “YES” in the step S77, that is, if the relevant point 122 and the drawing start point are coincident with each other, the drawing process is directly returned. On the other hand, if “NO” in the step S77, that is, if the relevant point 122 and the drawing start point are not coincident with each other, the drawing line 126 connecting the drawing start point and the touch coordinates T is erased in a step S79, the connecting line 124 connecting the relevant point 122 and the drawing start point is displayed on the operation screen 120 in a step S81, and it is determined whether or not the pair of ID numbers including the relevant point 122 and the drawing start point is present in a step S83. If “NO” in the step S83, that is, if the pair of ID numbers including the relevant point 122 and the drawing start point is not present, since a figure, etc. different from that on the question screen 100 is created, or a figure different from that on the question screen 100 is going to be created, it is determined to be a wrong answer, and then, the process proceeds to a step S101 shown in FIG. 21. On the other hand, if “YES” in the step S83, that is, if the pair of ID numbers including the relevant point 122 and the drawing start point is present, it is determined whether or not the already-connected-line flag 7222 of the corresponding pair of ID numbers is turned off in a step S85. That is, the CPU core 42 determines whether or not the two points 122 to be connected are correctly connected.

If “NO” in the step S85, that is, if the already-connected-line flag 7222 of the corresponding pair of ID numbers is turned on, the process proceeds to a step S95 shown in FIG. 21. On the other hand, if “YES” in the step S85, that is, if the already-connected-line flag 7222 of the corresponding pair of ID numbers is turned off, the already-connected-line flag 7222 of the pair of ID numbers is turned on in a step S87, and then, the process proceeds to a step S89 shown in FIG. 21.

In the step S89 shown in FIG. 21, it is determined whether or not any of the already-connected-line flags 7222 in the track data 722b is turned off. If “NO” in the step S89, that is, if all of the already-connected-line flags 7222 are the track data 722b are turned on, it is determined that a figure, etc. the same as the figure on the question screen 100 is drawn on the operation screen 120, and the characters of “correct answer” is displayed on the operation screen 120 (or question screen 100) in a step S91, the game end flag 732 is turned on in a step S93, and then, the drawing process is returned.

However, if “YES” in the step S89, that is, any one of the already-connected-line flags 7222 in the track data 722b is turned off, it is determined that a figure, etc. the same as that on the question screen 100 has not yet been drawn, the relevant point 122 is stored as (next) drawing start point in the step S95. Next, in a step S97, the drawing line 126 connecting the drawing start point and the touch coordinates T is displayed on the operation screen 120. Then, in a step S99, a setting process of the determination area is executed, and the drawing process is returned.

Also, as shown in FIG. 20, if the pair of ID numbers including the relevant point 122 and the drawing start point is not present in the step S81, and it is determined to be a wrong answer, the characters of “wrong answer” is displayed on the operation screen 120 (or question screen 100) in the step S101. Then, in a step S103, the game end flag 732 is turned on, and then, the drawing process is returned.

FIG. 22 is a flowchart showing a determination area setting process in the step S59 shown in FIG. 19 and in the step S99 shown in FIG. 21. As shown in FIG. 22, when starting a setting process of the determination area, the CPU core 42 determines whether or not the pair of ID numbers showing that the already-connected-line flag 7222 is turned off includes the ID number of the drawing start point in a step S111. If “NO” in the step S11, that is, if the pair of ID numbers showing that the already-connected-line flag 7222 is turned off does not include the ID number of the drawing start point, the determination area 22a of each of the points 122 is set (changed) to “middle” in a step S117, and then, the determination area setting process is returned.

However, if “YES” in the step S111, that is, the pair of ID numbers showing that the already-connected-line flag 7222 is turned off includes the ID number of the drawing start point, a determination area 22a of each of the points 122 except for the drawing start point out of the respective points 122 which includes the drawing start point and shows that the already-connected-line flag 7222 is turned off is set (changed) to “large” in a step S113. That is, the determination area 22a of the point 122 to be designated next is enlarged. Then, in a step S115, the determination area 22a of the point 122 except for the point 122 whose determination area 22a is set to “large” is set (changed) to “small”, and the determination area setting process is returned. That is, the determination area 22a of the point 122 not to be designated next is reduced.

According to this embodiment, a determination area of a point to be designated next is made large, a determination area of the point not to be designated is made small, and this makes it easy to instruct an object to be designated next even if a multiplicity of objects are displayed on the display area.

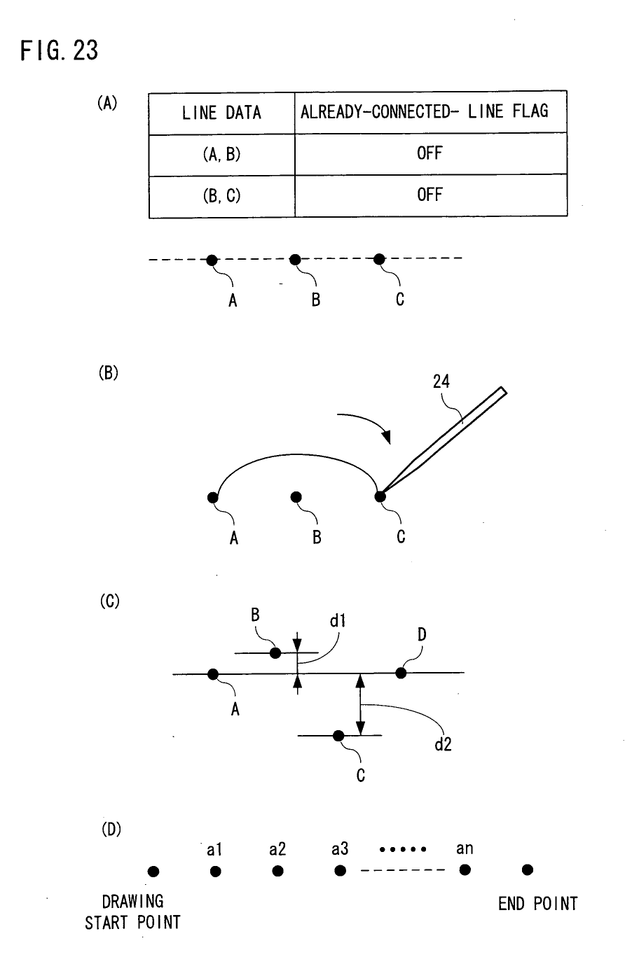

It is noted that although a detailed description is omitted in this embodiment, three or more points 122 may be arranged on the straight line so as to be connected with each other. For example, as shown in FIG. 23 (A), the point A, the point B, and the point C are arranged on the straight line, the line data 7220 includes a pair of ID numbers (A, B) and a pair of ID numbers (B, C), and assuming that these already-connected-line flags 7222 are turned off. If a player directly performs a drag operation from a point A, that is, performs a drag operation to avoid the determination area 22a (not illustrated) of the point B to connect the point A and the point C as shown in 23 (B), the pair of ID numbers (A, C) is not present in the line data 7220, and therefore, for a true or false determination method described above in the embodiment, it is determined that the drag operation by the player is wrong, resulting in a wrong answer. However, a connecting line 124 is displayed (drawn) between the point A and the point C on the operation screen 120, and it seems that the point A, point B, and point C are connected with each other, leading the player to have a misunderstanding of a correct connection.

In order to avoid this, examination of a true or false determination described below is appropriate. It should be noted that the true or false determination described below is executed in a case that the drawing start point and a certain point 122 are connected with each other, if the pair of ID numbers as to the drawing start point and the certain point 122 are not included in the line data 7220.

Additionally, even if the point 122 exists between the drawing start point and the end point, in a case that a distance from the line connecting the drawing start point and the end point exceeds a fixed distance L (10 dots, for example), it is determined that the point is not on the straight line and excluded from the object as a true or false determination. For example, the point B and the point C shown in FIG. 23 (C) exist between the drawing start point A and the end point D, and assuming that a distance between the straight line connecting the drawing start point A and the end point D, and the point B is d1, and a distance between the straight line and the point C is d2. If the distance d1 and the distance d2 are within fixed distances L, the point B and the point C becomes an object as the true or false determination. However, if the distance d1 and the distance d2 exceed the fixed distances L, the point B and the point C are excluded from the object as the true or false determination.

For example, as shown in FIG. 23(D), assuming that there are n points (a1, a2, a3, . . . ,an) which exist between the drawing start point and the end point and have distance d that is away from the straight line connecting the drawing start point and the end point and is within the fixed distance L. In such a case, the drawing start point and the point a1 are first connected with each other, that is, the drawing line 126 is displayed (the same is true for the following), and then, it is determined whether or not the pair of ID numbers including the points is included in the line data 7220. If the pair of ID numbers exists, the already-connected-line flag 7222 as to the pair of ID numbers is turned on to connect the point a1 and the point a2 with each other. Then, it is determined whether or not the pair of ID numbers including the point a1 and the point a2 is included in the line data 7220. In this manner, whether or not the pair of ID numbers is included in the line data 7220 is determined in order. Finally, the point an and the end point are connected with each other, and it is determined whether or not the pair of ID numbers including the point an and the end point is included in the line data 7220. That is, such a determination process is executed by n+1 times. It is noted that if the pair of ID numbers is not included in the line data 7220, it is determined that the drag operation by the player is erroneous at the time to display the wrong answer on the operation screen 120 (question screen 100) as described above.

It is noted that in this embodiment, although in a case that a figure, etc. the same as the figure, etc. displayed on the question screen is created on the operation screen, a correct answer is determined, it is not necessarily to be limited thereto. For example, it is conceivable that in order to raise a difficulty level of the question, a solid line is not displayed as to the objects except for the pair of objects to be connected by the player. For example, only points may be displayed on the operation screen. In such a case, the track data for the question screen and the track data for the operation screen are prepared. Then, the line data showing that the already-connected-line flag is turned on out of the track data for the question screen is removed from the track data for the operation screen. In such a case, even if a figure, etc. the same as the figure, etc. displayed on the question screen is not created on the operation screen, a correct answer is determined. It is noted that whether the correct answer or not is determined depending on whether or not all the already-connected-line flags corresponding to the line data included in the track data (track data for the operation screen, here) are turned on as described above.

Also, although a touch panel is utilized as a pointing device in this embodiment, it is not limited thereto. As another example, a computer mouse, a touch pad, a pen tablet, etc. are available. It is noted that in such a case, it is necessary to display an instruction image such as a mouse pointer, etc.

In addition the makeup of the game apparatus should not be limited to the makeup of the above-described embodiment. For example, the one LCD may be appropriate, or the touch panel may be provided on each of the two LCDs. Also, two speakers are provided on both sides.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A storage medium storing a training program which makes a player instruct a plurality of objects displayed on a screen with a pointing device to thereby cause a computer to execute a process relating to the instructed objects,
said training program makes said computer function as
an input coordinates detecting means for detecting input coordinates on said screen instructed by said pointing device;
a start object determining means for determining one start object out of all the objects on the basis of the input coordinates detected by said input coordinates detecting means; and
a determination area setting means for setting a determination area corresponding to a next candidate object to be instructed next according to a predetermined condition stored in a storage means so as to become larger than a predetermined size when the start object is determined by said start object determining means.

2. A storage medium storing a training program according to claim 1, wherein
said determination area setting means sets a determination area corresponding to an object except for the next candidate object so as to become smaller than said predetermined size.

3. A storage medium storing a training program according to claim 1, wherein
said determination area setting means sets the determination areas corresponding to all the objects to the predetermined size when said next candidate object is not present.

4. A storage medium storing a training program according to claim 1, wherein
said predetermined size includes a display area of said object.

5. A storage medium storing a training program according to claim 1, wherein
said training program further causes said computer to function as an object-related processing means, when the start object is determined by said start object determining means, and then, the input coordinates detected by said input coordinates detecting means is included in any of said determination areas, for executing a process relating to said object corresponding to said determination area.

6. A storage medium storing a training program according to claim 1, wherein said predetermined condition is a group of the objects to be connected.

7. A storage medium storing a training program according to claim 6, wherein
said object-related processing means includes a true or false determining means, when said start object is determined, and then, said input coordinates is included in any of said determination areas, for determining whether an object corresponding to said determination area is said next candidate object or not, a connection information storage controlling means for storing in said storage means connection information indicating that said start object and said next candidate object are connected with each other when the object is determined to be the next candidate object by said true or false determining means, a connection determining means for determining whether or not all connection information as to the objects to be connected are stored by said connection information storage controlling means, and a purpose attainment determining means for determining that a purpose is attained when it is determined that all the connection information are stored in said storage means by said connection determining means.

8. A storage medium storing a training program according to claim 7, wherein
said purpose attainment determining means determines that said purpose is not attained when said true or false determining means determines that the object is not the next candidate object.

9. A storage medium storing a training program according to claim 7, wherein
said start object determining means determines said start object when said input coordinates detecting means detects a shift from a state in which the input coordinates is not detected to a state in which the input coordinates is detected, or when the true or false determining means determines that the object is the next candidate object.

10. A training apparatus which makes a player instruct a plurality of objects displayed on a screen with a pointing device to thereby cause a computer to execute a process relating to the instructed objects, comprising:
a input coordinates detecting means for detecting input coordinates on said screen to be instructed by said pointing device;
a start object determining means for determining one start object out of all the objects on the basis of the input coordinates detected by said input coordinates detecting means; and
a determination area setting means for setting a determination area corresponding to a next candidate object to be instructed next according to a predetermined condition stored in the storage means so as to become larger than a predetermined size when the start object is determined by said start object determining means.

11. A training control method which makes a player instruct a plurality of objects displayed on a screen with a pointing device to thereby cause a computer to execute a process relating to the instructed objects, includes following steps of
(a) detecting input coordinates on said screen to be instructed by said pointing device;
(b) determining one start object out of all the objects on the basis of the input coordinates detected by said step (a); and
(c) setting a determination area corresponding to a next candidate object to be instructed next according to a predetermined condition stored in the storage means so as to become larger than a predetermined size when the start object is determined by said step (b).
